(19) United States
(12) Patent Application Publication
(10) Pub. No.: US 2026/0251516 A1
(43) Pub. Date: Aug. 27, 2026

(54) SMART ROBOTIC SKINS WITH TACTILE, STRETCH AND TEMPERATURE SENSING BASED ON OPTICAL SENSING VIA OPTICAL FIBER

(71) Applicant: Xiaotian Steve Yao, Las Vegas, NV (US)

(72) Inventor: Xiaotian Steve Yao, Las Vegas, NV (US)

(21) Appl. No.: 19/652,893

(22) Filed: Apr. 20, 2026

Related U.S. Application Data
(63) Continuation-in-part of application No. 18/741,685, filed on Jun. 12, 2024.
(60) Provisional application No. 63/507,524, filed on Jun. 12, 2023.
(60) Provisional application No. 63/791,188, filed on Apr. 18, 2025.

(51) Int. Cl. G01L 5/166; G01L 1/24

(52) U.S. Cl. CPC G01L 5/166; G01L 1/242

(57) ABSTRACT

The technology disclosed in this patent document can be implemented to provide a smart skin-like multi-layer sensing structure to include an optical fiber to provide spatially distributed optical sensing of a contact with the structure or the temperature based on changes in the optical fiber in response to the contact or temperature for various applications including robotics and others.

### PRIORITY CLAIMS AND CROSS-REFERENCE TO RELATED APPLICATION(S)

This patent document claims priority of, and benefits of U.S. Provisional Patent Application No. 63/791,188 entitled “SMART ROBOTIC SKINS WITH TACTILE, STRETCH AND TEMPERATURE SENSING BASED ON OPTICAL SENSING VIA OPTICAL FIBER” and filed Apr. 18, 2025.

In addition, this patent document is a continuation-in-part of co-pending U.S. patent application Ser. No. 18/741,685, and is published as U.S. Patent Application Publication No. US20240410770A1, entitled “MULTI-LAYER ARTIFICIAL ROBOTIC SKINS WITH TACTILE, STRETCH AND TEMPERATURE SENSING CAPABILITIES” and filed on Jun. 12, 2024 which claims the priority and benefits of U.S. Provisional Application No. 63/507,524 entitled “MULTI-LAYER ARTIFICIAL ROBOTIC SKINS WITH TACTILE, STRETCH AND TEMPERATURE SENSING CAPABILITIES” and filed on Jun. 12, 2023, which are incorporated by reference as part of the disclosure of this patent document.

### TECHNICAL FIELD

This patent document discloses designs of sensing devices, including multi-layer structures with optical fiber sensing as artificial robotic skins for various applications.

### BACKGROUND

Surface sensing using tactile sensor arrays can be used to construct robotic skin devices for various applications.

### SUMMARY

Surface sensing may be implemented by tactile sensor arrays in form of electronic sensors. However, various implementations of electronic sensors may be subject to certain technical limitations, including intricate wiring layouts, potentially high energy consumption, inter-sensor crosstalk, and susceptibility to electromagnetic interference. Optical sensing for surface sensing can provide an alternative sensing mechanism that may reduce or eliminate the above technical limitations of electronic sensing.

The disclosed technology in this patent document can be implemented to construct a multi-layer device capable of sensing to include, in one embodiment, a layer that includes force sensing elements spatially distributed relative to one another, each force sensing element structured to transmit a force exerted on a first end of the sensing element on a first side of the layer to a second end of the forcing sensing element on a second side of the layer opposite to the first side; and an optical fiber located on the second side of the layer and coupled to the force sensing elements at different locations along a length of the optical fiber. The optical fiber includes a first terminal that receives input light and a second terminal, and is coupled to the second end of each force sensing element to receive a force transmitted from the force sensing element to exhibit a localized birefringence in the optical fiber induced by the transmitted force at a location of the optical fiber coupled to the force sensing element to indicate the transmitted force so that different locations of the optical fiber coupled to the different force sensing elements of the layer generate a spatially distributed sensing of forces experienced by the different force sensing elements.

In another embodiment, a multi-layer device capable of sensing can include a layer that includes force sensing elements spatially distributed relative to one another, each force sensing element structured to transmit a force exerted on a first end of the sensing element on a first side of the layer to a second end of the forcing sensing element on a second side of the layer opposite to the first side; a front sensing layer coupled to the first side of the layer to receive one or more forces to be transmitted by the force sensing elements to the second side of the layer; and an optical fiber located on the second side of the layer and coupled to the force sensing elements at different locations along a length of the optical fiber. The optical fiber includes a first terminal that receives input light and a second terminal, and is coupled to the second end of each force sensing element to receive a force transmitted from the force sensing element to exhibit a localized birefringence in the optical fiber induced by the transmitted force at a location of the optical fiber coupled to the force sensing element to indicate the transmitted force so that different locations of the optical fiber coupled to the different force sensing elements of the layer generate a spatially distributed sensing of forces experienced by the different force sensing elements.

In one implementation of the above devices, an optical detection module is included and is coupled to the first terminal of the optical fiber to launch light into the optical fiber and receive backscattered light from the optical fiber for measuring the light that carries information of the localized birefringence in the fiber induced by transmitted forces by the different force sensing elements. In some implementations, the optical detection module may include an optical frequency domain reflectometer (OFDR) with polarization analysis capability for obtaining distance resolved birefringence along the optical fiber with high spatial resolution, or the optical a time domain reflectometer (OTDR) with polarization analysis capability for obtaining distance resolved birefringence along the optical fiber with high spatial resolution. In addition, the optical detection module can be designed to include a pulsed light source to generate light pulses to the optical fiber so that the returned light pulses from the optical fiber can be detected and processed to measure a spatial distribution of the force or temperature in the optical fiber based on Brillouin time domain reflectometry (BOTDR) measurements.

In one implementation of the above devices, an optical detection module may be provided to include (1) a first optical port coupled to the first terminal of the optical fiber to send light into the optical fiber and (2) a second optical port coupled to the second terminal of the fiber to receive light from the optical fiber and to include an optical interferometer to process the received light from the optical fiber to produce an interferometer optical output having polarization crosstalk peaks with their amplitude indicative of the forces exerted on the optical fiber. The optical detection module may be configured to measure both the amplitudes and spacings of the polarization crosstalk peaks to determine temperature distribution along the optical fiber. In some applications, the optical detection module may include a distributed polarization crosstalk analyzer (DPXA) that processes the received light from the optical fiber to measure distance resolved polarization crosstalk peaks along the optical fiber, with their amplitudes indicative of the force and the spacings indicative of the local temperature.

In yet another implementation, an optical detection module may be provided and coupled to the first terminal of the optical fiber to launch light into the optical fiber and receive light from the optical fiber and to measure the light that carries information of the localized birefringence in the optical fiber induced by transmitted forces by the different force sensing elements, wherein the optical detection module is further configured to process the received light from the optical fiber to measure a spatial temperature and strain distributions along the length of the optical fiber.

In another aspect, the disclosed technology can be implemented to construct a multi-layer device capable of operating as a robotic sensing system. This device includes a deformable layer that includes a deformable material structured to include through holes spatially separated from one other, and force sensing elements disposed in the through holes, each force sensing element structured to transmit a force exerted on a first end of the sensing element on a first side of the layer to a second end of the forcing sensing element on a second side of the layer opposite to the first side; a front sensing layer coupled to the first side of the deformable layer to deform with the deformable layer and to receive one or more forces to be transmitted by the force sensing elements to the second side of the deformable layer; and an optical fiber located on the second side of the deformable layer and coupled to the force sensing elements at different locations along a length of the optical fiber. The optical fiber includes a first terminal that receives input light and a second terminal, and is coupled to the second end of each force sensing element to receive a force transmitted from the force sensing element to exhibit a localized birefringence in the optical fiber induced by the transmitted force at a location of the optical fiber coupled to the force sensing element to indicate the transmitted force so that different locations of the optical fiber coupled to the different force sensing elements of the layer generate a spatially distributed sensing of forces experienced by the different force sensing elements. This device further includes an optical detection module coupled to the optical fiber to receive light from the optical fiber to measure the received light to obtain information on a spatial force distribution or a spatial temperature distribution on the front sensing layer.

In one implementation, the optical detection module includes a first optical port coupled to a first terminal of the optical fiber to send light into the optical fiber and a second optical port coupled to a second terminal of the fiber to receive light from the optical fiber for measuring the received light to obtain information on the spatial force distribution or the spatial temperature distribution on the front sensing layer. In another implementation, the optical detection module includes an optical port coupled to one terminal of the optical fiber to send light into the optical fiber and to receive light from the optical fiber for measuring the received light to obtain information on the spatial force distribution or the spatial temperature distribution on the front sensing layer.

The above features and their implementations associated with the disclosed embodiments and other embodiments are disclosed in greater detail in the drawings, the description and the claims.

### BRIEF DESCRIPTION OF THE DRAWINGS

FIGS. 1 through 13 illustrate various examples and implementations of the disclosed multi-layer structures with optical fiber sensing as artificial robotic skins:

FIG. 1 shows an example of the multi-layer structure of a smart skin for human-like robots of the disclosed technology. The skin in this example includes three layers. The base layer is for laying the optical fiber, the middle layer is an elastic or deformable layer with an array of holes to allow force/pressure pillars to go through for transmitting the force/pressure to the fiber, and the top layer is a protective layer to cover the elastic layer and the pillars down below. The force transmitting pillars are made with relatively hard materials, such as plastic or even metal, which is placed on top of the fiber. When a force or pressure is applied on the top layer at a particular location, the pillar at that location will be pushed downward and transmit the force to the fiber beneath it, which will induce a birefringence in the fiber at that particular location via the photo-elastic effect. The amount of birefringence is directly proportional to the force applied. A distributed birefringence sensor system can be used to periodically measure the birefringence distribution and convert the birefringence readings into force readings.

FIG. 2 includes FIG. 2a and FIG. 2b. FIG. 2a shows the top view of the base layer on which the fiber is laid in a zig-zag pattern, with the spacing between the fibers defining the vertical resolution. Micro trenches with a depth less than the fiber radius can be pre-made on the base layer for guiding the fiber. The bottom of the trench should be plat for the maximum birefringence induction sensitivity for a giver transverse force. The fiber can be laid automatically with a fiber routing machine. Adhesive can be used to glue the fiber on the base plate with or without trench. FIG. 2b shows the side view of the base layer, which preferably has a thickness between 0.1 to 1 mm.

FIG. 3 includes FIG. 3a and FIG. 3b. FIG. 3a shows the top view of the middle elastic layer with an array of holes for guiding the force transmitting pillars to go through. This layer is directly put on top of the base layer and each line of the holes is directly on top of the optical fiber, with the optical fiber running cross the center of the holes. An adhesive may be used to glue this layer to the base layer. FIG. 3b shows the side view of the elastic layer, which preferably has a thickness between 0.2 to 1 mm.

FIG. 4 includes FIG. 4a and FIG. 4b. FIG. 4a shows the top view of the top layer with an array of pillars for transmitting the force/pressure to the fiber laid on the base layer through the holes in the middle layer. The pillars can be directly molded on the top sheet or can be made separately with or without attaching to the top sheet. FIG. 4b shows the side view of the top layer with the force-transmitting pillars. The thickness of the top sheet is preferably between 0.1 to 1 mm and the height of the thickness is between 0.2 mm to 1 mm.

FIG. 5 includes FIG. 5a and FIG. 5b. FIG. 5a shows a circular spiral fiber routing pattern while FIG. 5b shows a rectangular spiral pattern.

FIG. 6 shows an example of a different design of a force transmitting pillar where this design is to minimize the friction between the pillars and the holes in the middle elastic layer. In this example, a piston like structure is disclosed to include a shell and a rod as an example. The shells are inserted in the holes of the middle layer and the rods are inserted in their corresponding shells. In some implementations, both the shell and the rod can be made with or coated with a self-lubricating material, such as molybdenum disulfide (MoS2), graphite, polytetrafluoethylene (PTFE), linear polyrthylenes (PE), and hexagonal boron nitride (h-BN) et al, for minimizing the friction and the most repeatable force transmission.

FIG. 7 includes FIG. 7a and FIG. 7b. FIG. 7a shows how a smart skin works. The input fiber is connected to a distributed transverse sensing system to send in probe light into the system for distributed optical sensing and an optional output fiber is connected to guide the output light from the fiber to the optical detection module. The output fiber is not required if the sensor system is a single-ended device, such as a polarization-analyzing frequency domain reflectometery (PA-OFDR) based device. If the sensor system is a transmissive device, such as a distributed polarization crosstalk analyzer (DPXA), then the output fiber is connected to the system. FIG. 7b shows an example of the software for operating the sensor system where a lookup table can be created to link the fiber location corresponding to a force transmitting rod, and then to the location on the XY plane of the skin, and finally map the position of the forces applied onto the skin, with their magnitude displayed on a computer screen.

FIG. 8 shows an example of a distributed polarization analysis (DPA) system, PA-OFDR. TL: tunable laser; C1, C2, C3, C4, C5: couplers; PSG: polarization state generator (see Insert for details); PSA: polarization state analyzer; PMF: polarization maintaining fiber; SMF: single mode fiber; CIR1, CIR2: circulator; BPD1, BPD2: balanced photodetectors; FRM: Faraday rotation mirror; SMF-UT: SMF under test.

FIG. 9 shows an example of the data acquisition and processing flow chart for obtaining the state of polarization (SOP) matrix as a function of z. Note Ms(z) can be reduces to a 3×3 matrix if polarization dependent loss (PDL) in the fiber can be neglected.

FIG. 10 shows examples of measurements where FIG. 10(a) shows an example of measured birefringence curve along the SMF-UT with 10 different TF's applied onto 10 different fiber segments using the same length of glass-slides (12 cm) obtained with 10 repeated measurements and FIG. 10(b) shows an example of TF-induced birefringence as a function of TLF f. The error-bars are plotted in pink to show the measurement repeatability of our PA-OFDR system.

FIG. 11 includes FIG. 11(a) and FIG. 11(b). FIG. 11(a) shows an example of a ghost-peak-free distributed polarization crosstalk analyzer using a scanning white light Michelson interferometer. The inset shows the delay relation between the original and crosstalk components. Light with a short coherence length travelling in the fiber is polarized along its slow axis at input point A. Crosstalk is induced by a stress at point B where a small portion of light is coupled into fiber's fast axis. A relative delay at the output point C between the two polarization components is ΔZ. The location Z of crosstalk point B can be obtained from a measurement of ΔZ. FRM, MDL, PD, and DAQ are Faraday rotation mirror, Motorized Delay Line, photodetector, and data acquisition card, respectively. FIG. 11(b) show a photo of an example of a commercial ghost-peak free DPXA product developed by the inventor. With such an instrument, a spatial resolution of 6 cm, a measurement range up to 3.4 km, a crosstalk measurement sensitivity down to −80 dB, and a crosstalk dynamic range of 75 dB can be routinely achieved.

FIG. 12 shows an example of a typical polarization crosstalk curve measured with a distributed polarization crosstalk analyzer.

FIG. 13 includes FIGS. 13(a), 13(b) and 13(c) and shows an example a smart skin device in which the top layer has arrays of square shaped pillars for transmitting the force/pressure to the fiber laid on the base layer.

FIG. 14 shows an example of a 2D flexible tactile sensor array structure with three layers: FIG. 14(a) A fiber layer between a top layer and a bottom layer laid in a serpentine pattern. FIG. 14(b) Enlarged view of the top layer with a grid of touching pads interconnected with thin strips. FIG. 14(c) The fixture for laying out the sensing fiber on the bottom layer. FIG. 14(d) An enlarged view of a groove on the bottom layer with two different widths along the groove for fiber guiding and holding. (e) The assembled smart skin device with the sensing fiber laid in a serpentine pattern.

FIG. 15 shows a schematic of the DPA system for testing the prototype smart skin device. TLS: New Focus TLB-8800-L-CL Venturi tunable laser source; PMF: polarization maintaining fiber; C1, C2, C3: PMF couplers; C4: SMF coupler; PSG: polarization state generator; PSA: polarization state analyzer; CIR1, CIR2: optical circulators; BPD1, BPD2: balanced photodetectors; FRM1, FRM2: Faraday rotation mirrors; PC: personal computer. Inset: the location indices of the sensing nodes in a two-dimensional coordinate system.

FIG. 16 shows the mapping of the fiber distances to the sensing node coordinates in testing one the prototype smart skin devices. FIG. 16(a) Motorized XYZ platform programmed to apply pressures to each sensing node. FIG. 16(b) 1D birefringence vs. fiber distance l data obtained by DPA in response to an applied force at different sensing nodes (i, j) in FIG. 16(a). FIG. 16(c) The detected birefringence vs. z data can be converted to the applied force data at corresponding sensing node coordinates shown in FIG. 16(d).

FIG. 17 shows conducted force measurement sensitivity calibration. FIG. 17(a) A three-axis motorized platform and a digital force gauge used for obtaining force measurement sensitivity (FMS). FIG. 17(b) Birefringence values measured by the DPA system at sensor node (3,5) in response to different forces applied to the sensor node. FIG. 17(c) Data extracted from FIG. 17(b) and the corresponding linear fit. FIGS. 17(d) and (e) Measured birefringence vs. force curves at sensor nodes (8,9) and (12,2) and their linear fits. FIG. 17(f) The average birefringence vs. force slope or the FMS of the sensor array.

FIG. 18 shows measurements of the spatial resolution of the prototype smart skin device #1. FIG. 18(a) Birefringence peaks along the fiber from 3.0 m to 7.5 m induced by forces of 1.5 N, 2.5 N, and 5 N applied on five pairs of touching pads on the smart skin device. Insets show the details of the double peaks, validating that our sensor system has a spatial resolution better than 8 mm. FIG. 18(b) 3D presentation of the detected forces at 10 different sensing nodes corresponding to three different forces (1.5N, 2.5N, 5 N) applied to the 10 different locations on prototype smart skin device #1.

FIG. 19 shows validation of the spatial resolution enhancement using the curve fitting method. FIG. 19(a) Gaussian and Lorentzian fitting results of the birefringence distribution data along the fiber, generated via a single force-applying bump with a width 4 mm and applied forces from 1.0 N to 6.0 N with a step size of 1.0 N. FIG. 19(b) Measured birefringence distribution (black) along a single-mode fiber induced by a double-bump force-applying fixture with a 3.03 mm spacing and the underlying two Gaussian curves (dotted green and blue lines) with a spacing of 3.15 mm obtained from curve fitting. FIG. 19(c) Birefringence distributions induced by four double-bump fixtures with spacings of 1 mm, 2 mm, 3 mm, and 4 mm and an applied weight of 2 N. FIG. 19(d) Comparison of the spacings of the underlying Gaussian curve peaks with those of the double-bump fixtures. FIG. 19(e) Birefringence distributions induced by four triple-bump fixtures with spacings of 1 mm, 2 mm, 3 mm, and 4 mm, and an applied weight of 3 N. FIG. 19(f) Comparison of the spacings of the underlying Gaussian curve peaks with those of the triple-bump fixtures.

FIG. 20 shows measurements of 2D tactile sensing over a large area and involving a prototype smart skin device #2 with 52 sensing nodes. Inset in FIG. 20(a): device #2 with weight loading fixture resembling HBU on top. Insets b) and (c): the expanded views of induced birefringence distribution along the fiber at around 6.57 m to 6.77 m (corresponding to the sensing nodes in the upper red rectangular in inset a) and 9.60 m to 9.80 m (corresponding to the sensing nodes in the lower red rectangular in inset a), respectively, induced by the weight loading fixture.

FIG. 21 shows 3D data visualization of the forces detected by the sensing nodes in a prototype smart skin device #2, showing the capability of the device for sensing a large area and multi-point tactile sensing.

FIG. 22 shows another design for connecting adjacent touching pads in connection with the design in FIG. 14.

### DETAILED DESCRIPTION

Many animals generally have five sensing organs, with the eyes for seeing, the ears for hearing, the nose for smelling, the tongue for tasting, and the skin for feeling the physical stimulus and temperature variations. Among the five sensing organs, the first four are discrete sensors while the skin is a spatially distributed sensor over the animal's body that is capable of identifying or sensing the locations of stimulus on the skin, providing the sensed magnitudes of the stimulus at the locations of the stimulus, such as touching, pinching, punching, heating or cooling, among various sensing functions.

For robotic systems, discrete sensing capabilities for the functions of the eyes, ears, nose and tongue may be relatively easy to equip in robots using various sensor devices. For example, in most human-like robots today, video cameras are commonly used to capture images as the eyes to see and the microphones are used to receive audio as the ears to hear. Although not commonly deployed, the smelling and tasting capabilities may be implemented with some kind of chemical sensors capable of analyzing the contents of chemicals in the air for smelling or the substances in the form of solid or liquid as the function for tasting. However, the skin, the only distributed sensing system on the body of an animal, is much more complicated to make and implement, because an animal skin generally has millions of nerves distributed on the skin and connected to the brain via spinal nerves to sense stimulus and identify their locations. One potential way of emulating the sensing of the animal skin is to populate a large number of piezoelectric pressure sensors on a sheet structure. Powering such piezoelectric pressure sensors and transmitting their signals to a CPU for processing can face significant technical or engineering challenges in various practical applications.

The technology disclosed in this patent document can be implemented to provide a smart skin-like multi-layer structure to include an optical fiber to provide spatially distributed optical sensing of a contact with the structure or temperature.

Various features associated with the technology disclosed in this patent document are disclosed in the inventor's U.S. patent application Ser. No. 18/741,685 entitled “MULTI-LAYER ARTIFICIAL ROBOTIC SKINS WITH TACTILE, STRETCH AND TEMPERATURE SENSING CAPABILITIES” and filed on Jun. 12, 2024 which claims the priority and benefits of U.S. Provisional Application No. 63/507,524 entitled “MULTI-LAYER ARTIFICIAL ROBOTIC SKINS WITH TACTILE, STRETCH AND TEMPERATURE SENSING CAPABILITIES” and filed on Jun. 12, 2023, and is published as U.S. Patent Application Publication No. US20240410770A1, which is incorporated by reference as part of the disclosure of this patent document.

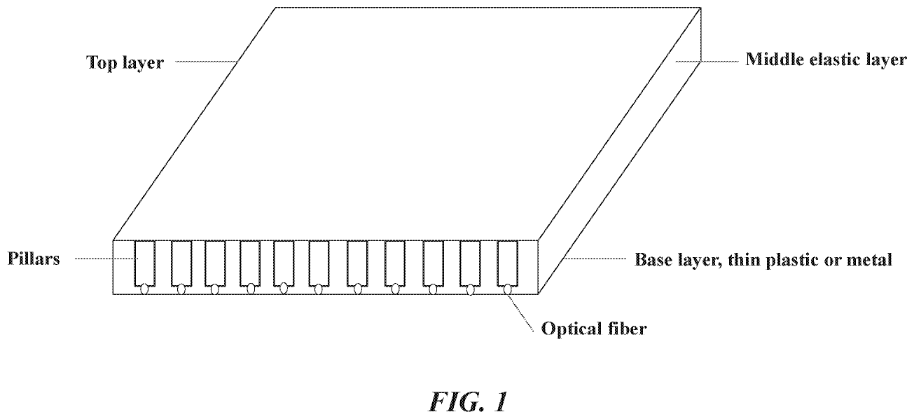

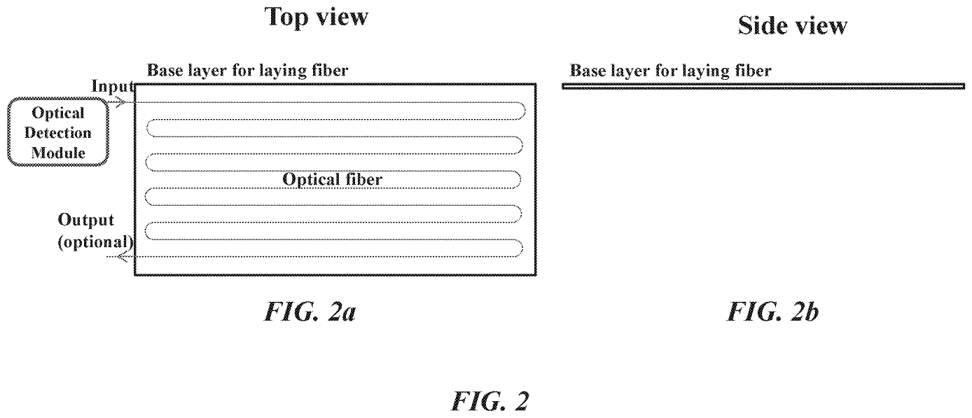

FIG. 1 shows an example of the structure of a multi-layer sensing structure as a smart skin for human-like robots based on the disclosed technology. This particular multi-layer sensing structure or the “skin” includes different layers and is structured to be deformable in response to interactions with its surroundings including a touch and can be stretched or tactile when interacting with external touches. The base layer on the bottom is for laying or supporting an optical fiber, the middle layer above the base layer is an elastic, deformable layer with an array of holes to hold force/pressure sensing elements in form of, e.g., pillars or rods, to allow the force/pressure sensing elements to penetrate through the middle layer for transmitting the sensed force/pressure amounts at different locations to the optical fiber which is coupled to the force/pressure sensing elements. The top layer above the middle layer is a protective layer to cover the elastic middle layer and the sensing pillars down below. This top layer interacts with the outside as a front sensing layer. The force/pressure sensing elements such as force transmitting pillars can be implemented in various configurations, including pillars made with relatively hard materials, such as plastic materials or metals. Each sensing pillar is placed on top of and is engaged to the optical fiber and different sensing pillars are placed at different locations of the optical fiber to be engaged to the optical fiber. The sensing pillars may be arranged as an array over the multi-layer structure and the optical fiber can be placed along a zig-zag pattern or other patterns to pass through the sensing pillars as shown in FIG. 2. Probe light is directed into the optical fiber to pass through locations within the optical fiber where the sensing pillars are engaged.

When a force or pressure is applied to or exerted on the top layer at a particular location, the pillar at that location will be pushed downward to press against the optical fiber below to transmit the force to the optical fiber. This interaction can induce a change in the optical birefringence in the optical fiber at that particular location via the photo-elastic effect in optical fiber. The amount of the locally induced birefringence at that location within the optical fiber is directly proportional to the force or pressure applied to that location of the optical fiber. The probe light in the optical fiber, when passing through that location of the optical fiber, interacts with the optical fiber at that location with the locally induced birefringence to carry information indicative of that induced birefringence due to the local force or pressure. The probe light can be measured to extract the information on the induced birefringence and this measurement can be used to determine the force or pressure applied to that location of the optical fiber. The probe light passes through different locations of the optical fiber carries the information of the induced birefringence at the different locations of the optical fiber and this optical fiber thus can be used as a spatially distributed birefringence sensor system to measure the birefringence distribution over time (e.g., periodically) and convert the birefringence readings into force readings. As will be discussed below, in addition to the induced birefringence, the distributed birefringence sensor system is also capable of measuring the strain and temperature variations along the optical fiber, and therefore can be used to read out the distance resolved birefringence, strain, and temperature values. The skin can be wrapped on the body of a robot to feel the location resolved touching, poking, pressing, stretching, and heat/cold sensations.

Examples for measurements of strain, stress, and temperature by using 1-dimensional and 2-dimensional distributed fiber-optic sensors based on sensing by polarization maintaining optical fiber of distributed polarization crosstalk distribution are disclosed in U.S. Pat. No. 9,476,699 entitled “Measurements of strain, stress and temperature by using 1-dimensional and 2-dimensional distributed fiber-optic sensors based on sensing by polarization maintaining fiber of distributed polarization crosstalk distribution,” which is incorporated by reference in its entirety as part of the disclosure of this patent document.

The sensing devices in the U.S. Pat. No. 9,476,699 are capable of measuring stress, strain, or temperature based on polarization crosstalk analysis in birefringence optical birefringent media including polarization maintaining fiber to measure polarization crosstalk distribution in polarization maintaining fiber by placing the PM fiber in a 1-dimensional or 2-dimensional configuration for sensing temperature, stress or strain in the PM fiber at different locations along the fiber with a high spatial sensing resolution, including simultaneous measurements of stress, strain and temperature from analyzing the probe light. For example, the U.S. Pat. No. 9,476,699 discloses a method for monitoring a temperature of an object by optical sensing that includes coupling a linearly polarized light of a broadband spectrum into an optical birefringent medium as a sensing element which is attached to an object to produce an optical output signal out of the optical birefringent medium; directing the optical output signal to transmit through a linear optical polarizer which is polarized in a direction to cause a mixing between the two orthogonal polarization modes in optical transmission light of the linear optical polarizer; directing the optical transmission light of the linear optical polarizer into an optical interferometer to obtain optical interference of light between the two orthogonal polarization modes in the optical birefringent medium to produce polarization crosstalk peaks; and measuring spacings of polarization crosstalk peaks present in the obtained optical interference to monitor a temperature at different locations of the optical birefringent medium attached to the object. The U.S. Pat. No. 9,476,699 also discloses an optical fiber sensor device that includes a sensor plate formed of a deformable or elastic material in contact with an object under measurement; a length of polarization maintaining (PM) fiber as a sensing element and engaged to the sensor plate at multiple engaging locations; an optical light source that produces probe light and is coupled to the PM fiber to deliver the probe light into the PM fiber; and a detector module coupled to receive probe light from the PM fiber and to measure the received probe light. The detector module includes an optical interferometer to processing the received probe light to produce an interferometer optical output having polarization crosstalk peaks. The detector module is configured to measure spacings of the polarization crosstalk peaks to determine temperature information of the sensor plate and the object. The U.S. Pat. No. 9,476,699 provides distributed fiber-optic strain sensors using polarization maintaining (PM) fiber as the sensing medium as discrete sensors and distributed sensors in 1D and 2D configurations based on the technology of ghost-peak free distributed polarization crosstalk analyzer (DPXA), commercially available from General Photonics Corporation. The force/pressure sensing elements in the smart skin device in FIG. 1 engaged at different locations of the optical fiber can be combined with the optical sensing using the distributed polarization crosstalk analyzer (DPXA) in U.S. Pat. No. 9,476,699.

FIG. 2 shows one example of how to deploy an optical fiber in the base layer in FIG. 1. FIG. 2a shows an example of the top view of the base layer on which the optical fiber is laid in a zig-zag pattern to be coupled to the sensing pillars or rods. For example, micro trenches with a depth less than the optical fiber radius can be pre-made on the base layer for guiding the optical fiber along the zig-zag path. The bottom of the trench should be plat for the maximum birefringence induction sensitivity for a giver transverse force. The optical fiber can be laid automatically with an optical fiber routing machine. In some implementations, an adhesive material may be used to glue the optical fiber on the base plate with or without trench. FIG. 2b shows the side view of the base layer, which may have a thickness between 0.1 to 1 mm in some implementations.

In this example of a distributed optical fiber sensor in FIGS. 1 and 2, the spacing between the fiber segments in the optical fiber along the vertical direction defines the vertical resolution of the two dimensional sensing and the spacing between two adjacent force-transmitting pillars or rods in each horizonal optical fiber segment defines the horizontal resolution.

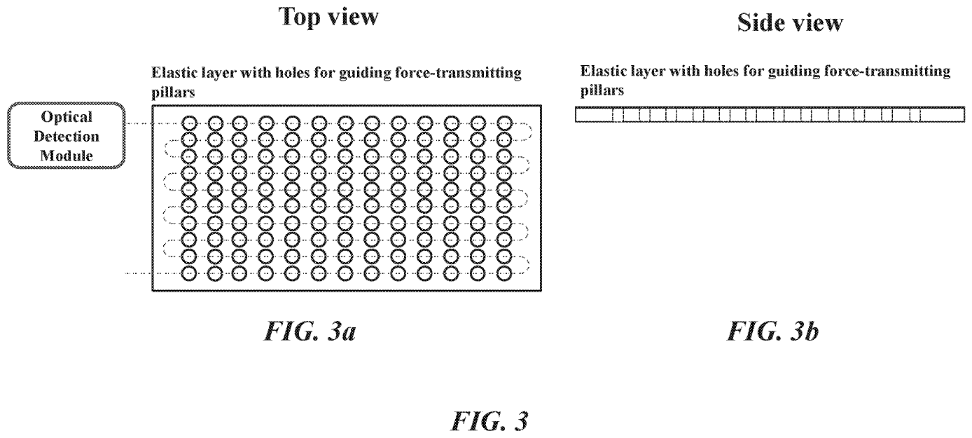

FIG. 3 shows one example of placing force/pressure sensing elements in the middle layer of the smart skin device in FIG. 1. FIG. 3a shows the top view of the middle elastic layer with an array of holes for guiding the force transmitting pillars to go through. In this example, this middle layer is directly put on top of the base layer and each line of the holes for holding the pillars is directly on top of the optical fiber, with the optical fiber running cross the center of the holes to be in contact with different pillars. In some implementations, an adhesive can be used to glue the middle layer to the base layer. FIG. 3b shows the side view of the middle elastic layer, which may have a thickness between 0.2 to 1 mm in some implementations.

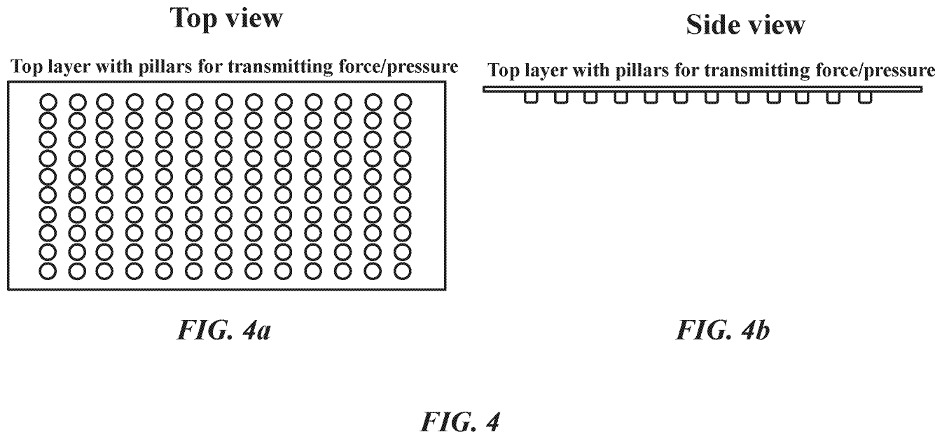

FIG. 4 shows one example of the top layer in the smart skin device in FIG. 1. FIG. 4a shows the top view of the top layer with an array of pillars for transmitting the force/pressure to the optical fiber laid on the base layer through the holes in the middle layer. In some implementations, the pillars can be directly molded on the top sheet or can be made separately with or without attaching to the top sheet. FIG. 4b shows the side view of the top layer with the force-transmitting pillars. The thickness of the top sheet may be between 0.1 to 1 mm and the height of the thickness is between 0.2 mm to 1 mm in some implementations.

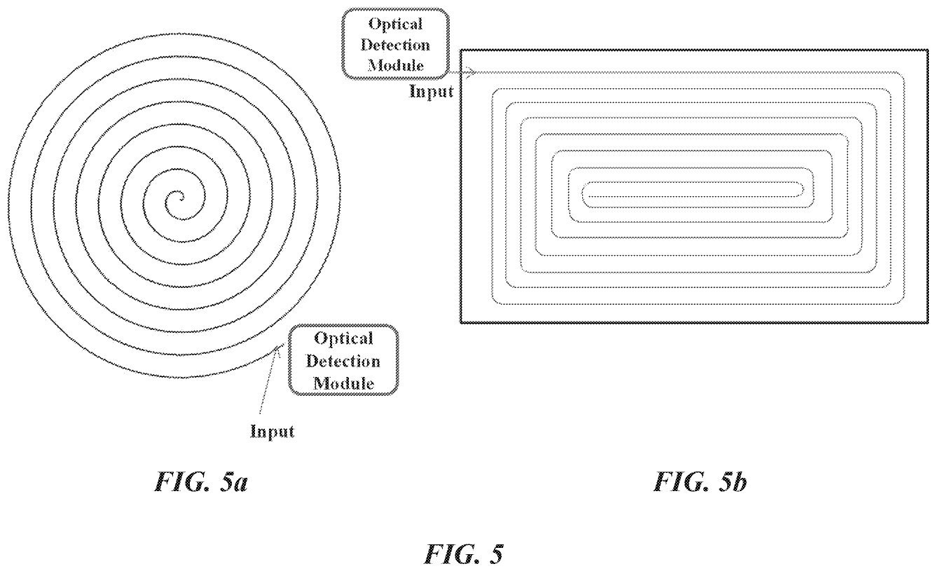

The optical fiber can be deployed in the base layer in various other configurations other than the zig-zag pattern in FIG. 2. FIG. 5 shows examples of different optical fiber layout patterns of the optical fiber where FIG. 5a shows a circular spiral optical fiber routing pattern and FIG. 5b shows a rectangular spiral pattern of the optical fiber.

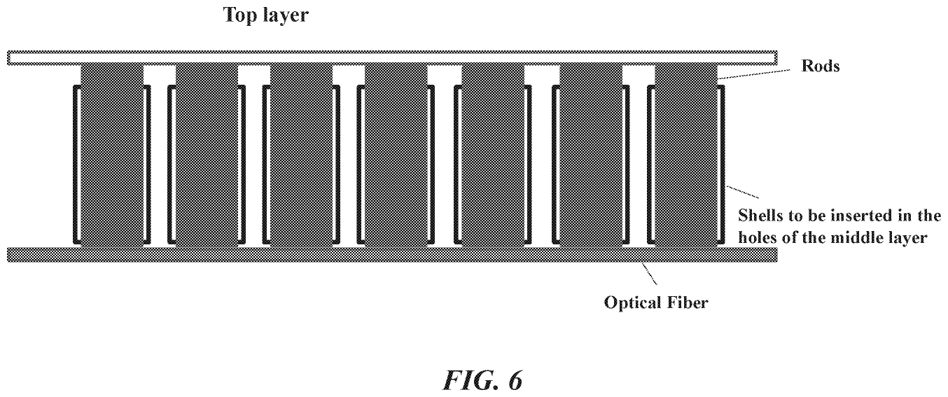

FIG. 6 shows an example of another design of a force transmitting pillar for the middle layer shown in the smart skin device in FIG. 1. This particular design can be used to minimize the friction between the pillars and the holes in the middle elastic layer by implementing a piston like structure to include a pillar shell with a hollow interior and a rod or pillar enclosed in the shell. The pillar shells are inserted in the holes of the middle layer and the rods or pillars are inserted in their corresponding shells. In some implementations, both the shell and the rod can be made with or coated with a self-lubricating material, such as molybdenum disulfide (MoS2), graphite, polytetrafluoethylene (PTFE), linear polyrthylenes (PE), and hexagonal boron nitride (h-BN), or a metal or alloy (e.g., brass), for minimizing the friction and the most repeatable force transmission.

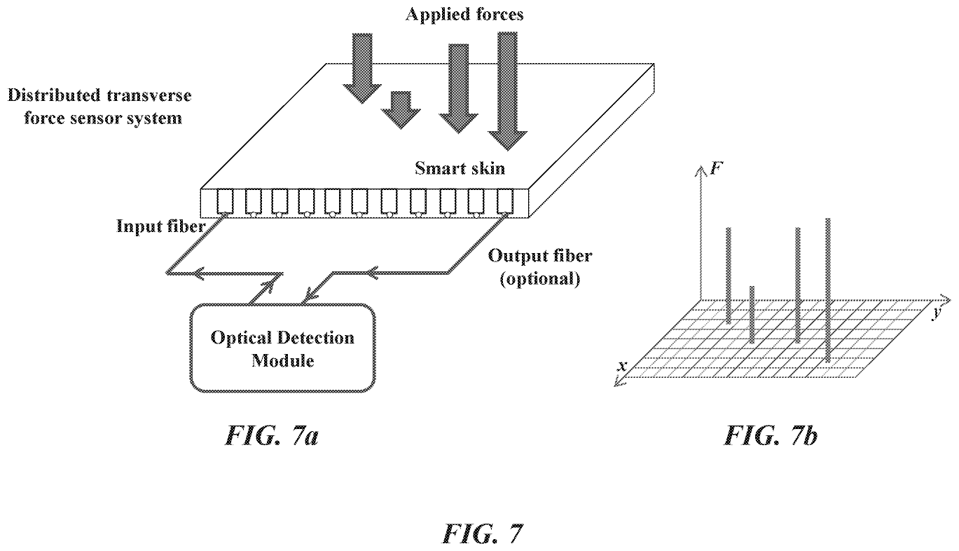

Referring to FIG. 7, FIG. 7(a) shows how the multi-layer smart skin works. In this example, an optical detection module is coupled to the input optical fiber where the probe light in directed into the input optical fiber to the different force/pressure sensing elements in the smart skin as part of a distributed transverse sensing system and the output optical fiber that sends the probe light to the optical detection module for measurements. This use of an input optical fiber and an output optical fiber is a transmissive fiber sensing system where the input fiber terminal is the input optical fiber and the output terminal of the same optical fiber is the output optical fiber. For example, such a transmissive fiber sensing system may include first and second optical ports where the first optical port is coupled to the first terminal of the optical fiber to send probe light into the system and the second optical port is coupled to the second terminal of the optical fiber to receive the returned light from the fiber for optical sensing, such as a distributed polarization crosstalk analyzer (DPXA).

In other implementations, the output optical fiber may not be needed when the optical sensor system is designed as a single-ended device that sends probe light into one terminal of the fiber and collects returned light from the same terminal of the fiber for optical sensing, such as a polarization-analyzing frequency domain reflectometery (PA-OFDR) based device disclosed in this patent document.

In either of the system designs, the system can be implemented with processing software where a lookup table can be created to link the fiber location corresponding to a force transmitting rod or pillar, and then to the location on the XY plane of the skin, and thus a mapping between the positions of the forces applied onto the skin, with their magnitudes of the forces at the different locations can be displayed on a computer screen, as shown in FIG. 7(b) in FIG. 7. If using the PA-OFDA as an interrogator, then standard telecommunication single mode optical fiber with core/cladding/buffer diameters of 9, 125, and 250 μm can be used. Optical fiber with smaller diameter can also be used to increase the sensing sensitivity. For example, single mode optical fiber with core/cladding/buffer diameters of 4, 60, and 100 μm or 6, 80, 135 μm can be used. In addition, high Rayleigh scattering fibers created by treating a regular optical fiber with UV radiation or using femotosecond laser to create scattering centers inside can also be used to enhance the measurement sensitivity and repeatability. If a DPXA system is used as the interrogator, the polarization maintaining (PM) optical fiber can be used. The birefringence axis of the PM fiber is aligned 45° from the surface normal of the skin for maximum sensitivity. Other distributed force/pressure sensing interrogation systems may also be used with the disclosed skin structure.

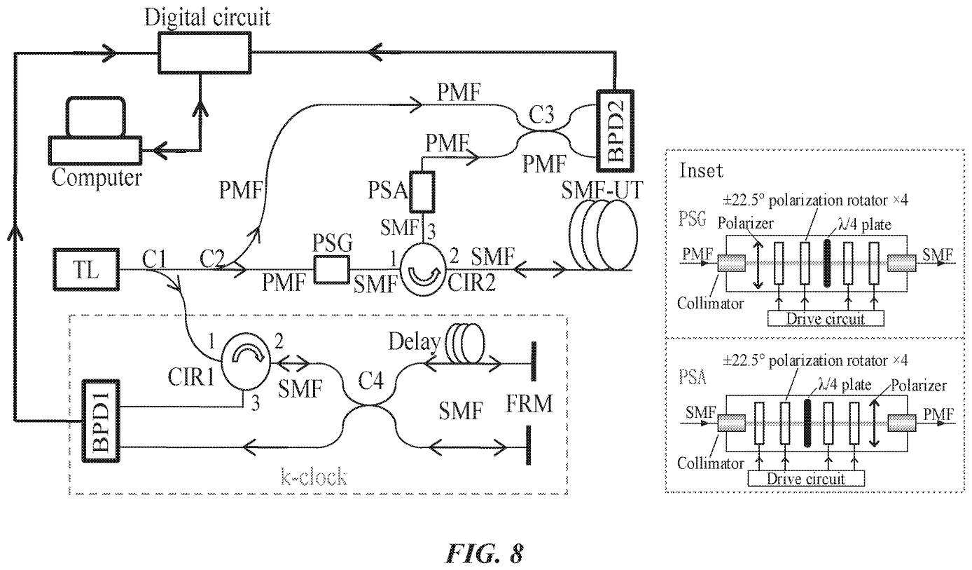

FIG. 8 shows a specific example of the basic schematic of a PA-OFDR as a single-ended device that sends probe light into one terminal of the fiber and collects returned light from the same terminal of the fiber for optical sensing [1,2]. In this example, the SMF-UT is a single-mode PM fiber that is coupled to the distributed force sensing elements in the robotic skin shown in FIG. 1. Light from a tunable laser (TL) with a long coherence length is coupled into the PM fiber. Around 5% is coupled out by a first coupler C1 to a k-clock consisting of a first circulator (CIR1) and an optical interferometer (e.g., a Michelson interferometer as shown) made with SMF in which two Faraday rotation mirrors (FRMs) are used to eliminate polarization fluctuations. The outputs from the optical interferometer are detected and amplified by a first balanced photodetector (BPD1) to get the incremental frequency of the TL. The light in the PMF continues to propagate and a fraction of this light (e.g., around 10%) is coupled out by a second coupler C2 as a local oscillator (LO) beam. The remaining light first goes through a polarization state generator (PSG) and is then directed into the SMF-UT via a second circulator (CIR2). The back scattered and reflected light from the SMF-UT is directed to port 3 of CIR2 and then goes through a polarization state analyzer (PSA) before entering a PM fiber to be mixed at a third coupler C3 with the LO beam from C2. The interference signals from two outputs of C3 are detected and amplified by a second balanced detector (BPD2), and the output of BPD2 is finally sent to the analog to digital converter (ADC) in the digital circuit board to be converted to digital signal with a desired resolution (e.g., 16 bit resolution). The zero crossings of the interference signal from the k-clock interferometer detected by BPD1 are converted to trigger pulses in the digital circuit to trigger the ADC so that the signal from BPD2 is digitized with equal frequency spacing. The working principle of the k-clock and the data processing algorithm can be found in detail in [3,4]. Fast Fourier transform (FFT) of the digitized signal then reveals the location information of backscattered and reflected light originated at different locations in the SMF-UT. As in [5-7], both PSG and PSA are made with binary magneto-optical (MO) crystals, as shown in the inset of FIG. 8. The PSG is capable of generating 4 distinctive SOPs. For example, the PSG may include four controllable polarization rotators 1, 2, 3, and 4 that are sequentially placed in the optical path. A quarter waveplate is placed between the rotators 2 and 3 to separate the 4 rotators into two pairs: rotators 1 and 2 as one pair and rotators 3 and 4 as another pair. In addition, an optional input polarizer may be placed in front of the first rotator 1 for aligning the input polarization with respect to the optical axis (c-axis) of the λ/4 plate. The input polarizer may be oriented in various directions, e.g., aligned with the c-axis, or 45° from the c-axis, or other predetermined angle. Each of the polarization rotators may be individually controlled by a control signal as illustrated. Polarization rotations of the rotators are controlled to produce the desired SOPs at the output. In addition, this PSG may also be used as a SOP analyzer or polarimeter to determine the SOP of the received light as is shown in the insert for PSA which is capable of analyzing any SOP with 4 distinctive logic states or MO settings.

The PSG and PSA devices can be implemented in various configurations, including designs invented by Dr. Xiaotian Steve Yao in U.S. Pat. No. 7,027,198B2 for Generation and analysis of state of polarization using tunable optical polarization rotators; U.S. Pat. No. 7,265,836B1 for In-line optical polarimeter using free-space polarization sampling elements; U.S. Pat. No. 7,436,569B2 for Polarization measurement and self-calibration based on multiple tunable optical polarization rotators; and U.S. Pat. No. 7,466,471 B2 for Optical instrument and measurements using multiple tunable optical polarization rotators, all of which are incorporated by reference as part of the disclosure of this patent document.

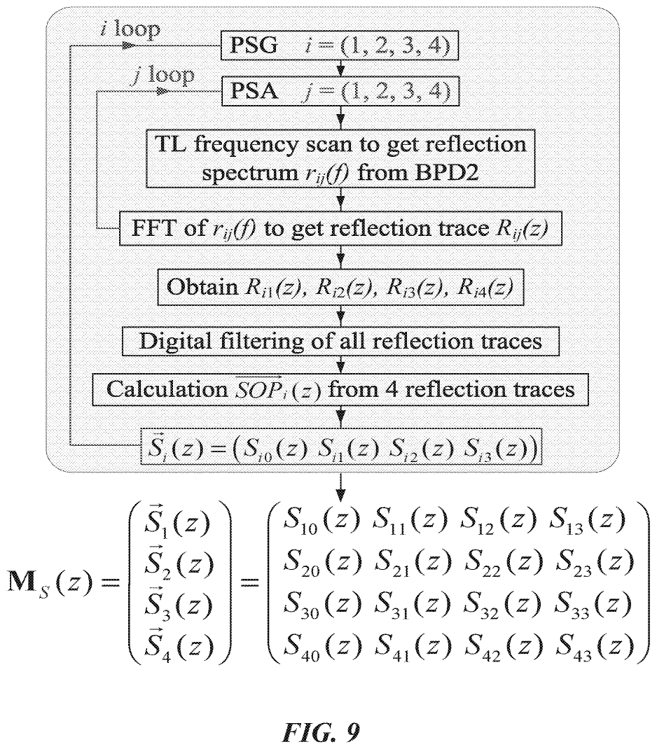

FIG. 9 shows an example of the data acquisition and processing flow chart for measuring the SOP matrix as a function of z. For each frequency scan of the TL, the PSG generates one of four SOPs and the PSA measures the SOP with four sequential MO settings, and a total of 16 frequency scans and PSG/PSA settings are required to get the full Stokes (or SOP) matrix Mₛ(z) of the signal returned from each point along the single mode optical fiber under test (SMF-UT) [1,]:

$${M}_{s} ( z ) = [ \begin{matrix}{S}_{1} ( z ) \\ {S}_{2} ( z ) \\ {S}_{3} ( z ) \\ {S}_{4} ( z )\end{matrix} ] = [ \begin{matrix}{S}_{10} ( z ) & {S}_{11} ( z ) & {S}_{12} ( z ) & {S}_{13} ( z ) \\ {S}_{20} ( z ) & {S}_{21} ( z ) & {S}_{22} ( z ) & {S}_{23} ( z ) \\ {S}_{30} ( z ) & {S}_{31} ( z ) & {S}_{32} ( z ) & {S}_{33} ( z ) \\ {S}_{40} ( z ) & {S}_{41} ( z ) & {S}_{42} ( z ) & {S}_{43} ( z )\end{matrix} ] \qquad ( 1 )$$

where Sᵢ(z)=[Sᵢ₀(z), Sᵢ₁(z), Sᵢ₂(z), Sᵢ₃(z)]^{T}, (i=1, 2, 3, 4), is the Stokes vector of the reflected or back scattered light at location z measured with the PSA corresponding to the ith SOP generated by the PSG. When a polarized light is directed to propagate in the SMF-UT, the evolution of the SOP of the light can be described using the well-known equation of motion of the Stokes vector Sᵢ(z) as shown below:

$$\frac{\partial S ( z )}{\partial z} = {W}_{rt} ( z ) \times S ( z ) , \qquad ( 2 )$$

where z is the distance of light propagated within the optical fiber, Wᵣₜ(z) is the local round-trip birefringence vector. In practice, one may use the following steps to calculate the birefringence [1]:

For a small optical fiber segment with a length of Δz, the SOP matrix Mₛ(z+Δz) at z+Δz relates to the SOP matrix at z by Mₛ(z+Δz)=M_{Δ}(z)Mₛ(z), where M_{Δ}(z) is the Muller matrix of the optical fiber segment Δz and can be obtained as

$${M}_{Δ} ( z ) = {M}_{s} ( z + Δ z ) {M}_{s}^{- 1} ( z ) \qquad ( 3 )$$

It can be shown that the retardation angle θ(z) can be expressed as [1]:

$$θ ( z ) = {cos}^{- 1} ( \frac{Tr [ {M}_{Δ} ( z ) ] - 1}{2} ) = \frac{2 \cdot 2 π Δ n ( z ) Δ z}{λ} \qquad ( 4 )$$

where the factor of 2 accounts for the round trip passage of light in the optical fiber segment. Finally, the local birefringence Δn(z) can be calculated from the θ(z) as

$$Δ n ( z ) = \frac{θ ( z ) λ}{4 πΔ z} \qquad ( 5 )$$

where λ is the wavelength. With the local birefringence obtained, the local transverse or lateral stress can be determined because it is linearly proportional to the birefringence via the photoelastic effect.

When a length of SMF is subject to a transverse line force (TLF) f, the birefringence Δn induced via the photo-elastic effect can be expressed as [8-10]:

$$Δ n = \frac{4 {n}^{3}}{π E} ( 1 + σ ) ( {p}_{12} - {p}_{11} ) ( \frac{f}{d} ) = ζ f \qquad ( 6 a )$$

where the proportion constant ζ relating the TLF and birefringence is defined as the TF measurement sensitivity:

$$ζ = \frac{4 {n}^{3}}{π dE} ( 1 + σ ) ( {p}_{12} - {p}_{11} ) \qquad ( 6 b )$$

Taking the parameters of fused silica: n≈1.46 at 1550 nm, E=6.5×10¹⁰ N/m, p₁₁=0.12, p₁₂=0.27 and σ=0.17, for a SMF with a cladding diameter d=125 μm, the proportion constant (is estimated to be 8.559×10⁻⁸ RIU/(N/m). Such a value is calculated by assuming the SMF made with fused silica with uniform stresses inside the core region, without considering the difference between the optical fiber core and cladding.

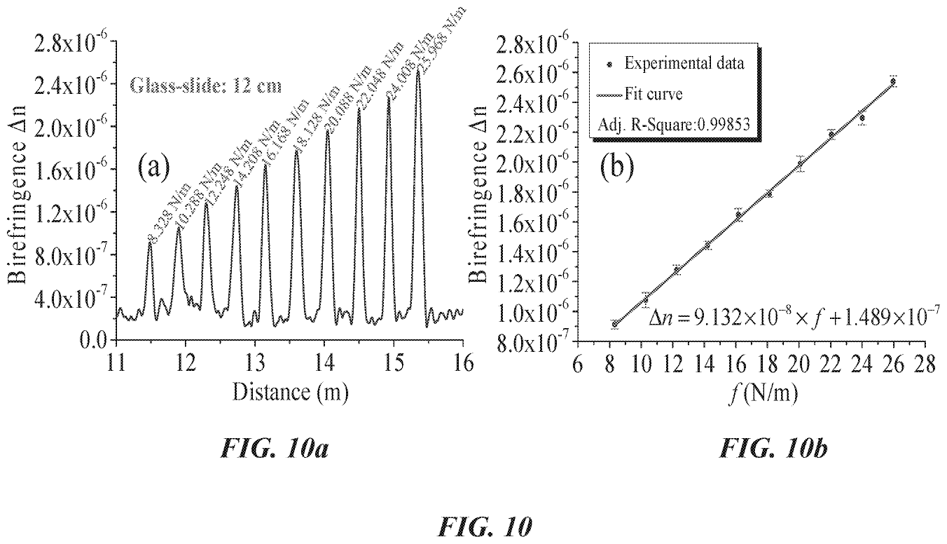

FIG. 10a shows an example of the measured birefringence curve along the SMF-UT with 10 different TF's applied onto 10 different optical fiber segments using the same length of glass-slides (12 cm) obtained with 10 repeated measurements. FIG. 10b shows the TF-induced birefringence as a function of TLF f. The error-bars are plotted in pink to show the measurement repeatability of our PA-OFDR system [2].

A fiber sensor system based the disclosed technology can be configured in some implementations to have a maximum and a minimum detectable TLFs of 1.68×10⁴ N/mm and 0.634 N/m, respectively, corresponding to a dynamic range of 44 dB. [2]. The force sensing spatial resolution is 3.7 mm, with a sensing range of 103 m, which can be extended to few km using a laser with longer coherent length. The sensitivity, dynamic range, measurement range and the spatial resolution are sufficient for making a large area of smart skin to cover a human-like robot.

Note that not only a PA-OFDA is capable of measuring transverse force/pressure described above, but also strain and temperature. Therefore, the smart skin has the capabilities of simultaneously feeling the touching, poking, pressing, stretching and heat/cold on the skin, which are important functions of real animal skins.

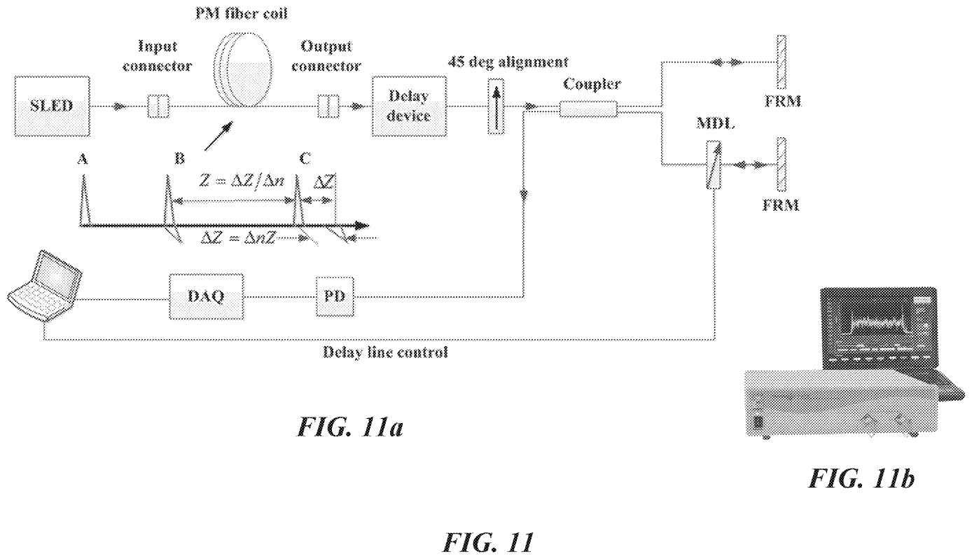

FIG. 11 illustrates a basic configuration for a distributed polarization crosstalk analyzer (DPXA) [11-14]. The “PM fiber coil” in FIG. 11 is the distributed sensing PM fiber which corresponds to the fiber shown in FIG. 1. Examples of optical fiber sensing devices for measuring distributed polarization crosstalk in polarization maintaining optical fiber and optical birefringence material are included in U.S. Pat. No. 8,599,385 for Measuring distributed polarization crosstalk in polarization maintaining fiber and optical birefringent material, which is incorporated by reference as part of the disclosure of this patent document. A broadband light source, such as a polarized super luminescent diode source (SLED) with a very short coherence length (~25 μm, corresponding to a 3-dB Gaussian line width of 30 nm) is coupled into the slow axis of a PM optical fiber under test (FUT) (point A of inset in FIG. 11). Assume at point B, a polarization crosstalk is induced by an external disturbance and then some lights are coupled into the fast axis of the PM optical fiber with a coupling coefficient parameter h=I₁/I₂, where I₁ and I₂ are the light intensities in the fast and slow axes of the PM optical fiber, respectively. Because the polarized lights along the fast axis travel faster than that along the slow axis, at output of the optical fiber the faster light component will be ahead of the slow component by ΔZ=ΔnZ, where ΔZ is an optical path length difference, Δn is a group birefringence of the PM optical fiber and Z is the optical fiber length between the point where the crosstalk occurs (B) and the output end (point C). A polarizer oriented at 45° to the slow axis of the PM FUT was placed at the end of the optical fiber. Polarization components from both slow and fast axes were projected onto a same direction of the linear polarizer axis so as to produce interference pattern between those two components in a scanning Michelson interferometer. When the relative optical path length is scanned, an interference peak appears whenever these two polarization components are overlapped in the space but disappears when they are separated more than a coherence length of light source (i.e. SLED). Then the group birefringence Δn of PM FUT between two positions B and C can be calculated as following:

$$Δ n = Δ Z / Z \qquad ( 7 )$$

It is evident from Eq. (7) that the accuracy of Δn depends on the measurement accuracies of both ΔZ and Z.

In general, the transverse force induced coupling ratio or polarization crosstalk h, which is defined as the ratio between the coupled power in the fast axis and the original power in the slow axis, can be expressed as [15,16]:

$$h = {F}^{2} {sin}^{2} 2 α \cdot {\{ \frac{sin [ π \sqrt{1 + {F}^{2} + 2 F cos 2 α} ( l / {L}_{b 0} ) ]}{\sqrt{1 + {F}^{2} + 2 F cos 2 α}} \}}^{2} \qquad ( 8 )$$

where α is the angle between the applied force f and the fast axis of the PM optical fiber (the force angle), L_{b0} is the beat length of PM optical fiber of the unstressed section, and F is the normalized force given by

$$F = \frac{2 {n}^{3} {L}_{b 0} f ( 1 + μ ) ( {P}_{12} - {P}_{11} )}{πλ rE} \qquad ( 9 )$$

In Eq. (9), r is the radius of the PM optical fiber, n is the refractive index of the fast axis, f is the magnitude of the force applied to the optical fiber per unit length (f=Fₑₓ/l), μ is the Poisson coefficient, p₁₂ and p₁₁ are the optical strain coefficients, is the wavelength of the light source, and E is the Young's modulus of the optical fiber. Using the parameters for fused silica, Eq. (9) can be simplified to:

$$F = \frac{5.46 {L}_{b 0}}{r λ} f \qquad ( 10 )$$

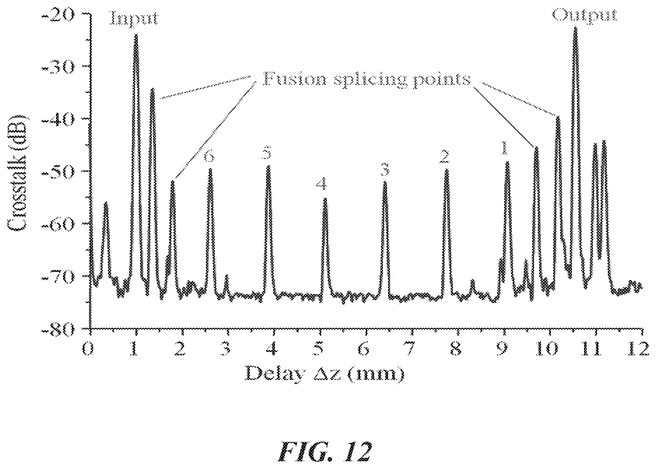

FIG. 12 shows a typical polarization crosstalk curve as a function of delay (from the MDL in FIG. 11) measured with a DPXA. The peaks marked Input and Output are due to the birefringence axis misalignments at the input and output connectors. There are also four crosstalk peaks from the axis misalignment at four fusion splice points. The peaks labeled 1-6 are the transverse force induced crosstalks by placing different weights on the optical fiber at different locations along the PM optical fiber. Clearly, the magnitude and location of a transverse force can be uniquely measured and identified.

The disclosed sensing system with DPXA is capable of measuring the transverse a long a PM optical fiber for with a length range up to 4 km and a spatial resolution of 6 cm. The length range is sufficient to make a skin sufficiently large to cover the body of a human-like robot, but the spatial resolution is not. Further improvement is required. In addition, the DPXA is also capable to sense the temperature along the optical fiber [17,18] and therefore enables the smart skin to simultaneously sense the temperature variations at different locations on the skin. Again, the temperature sensing spatial resolution also needs to be improved.

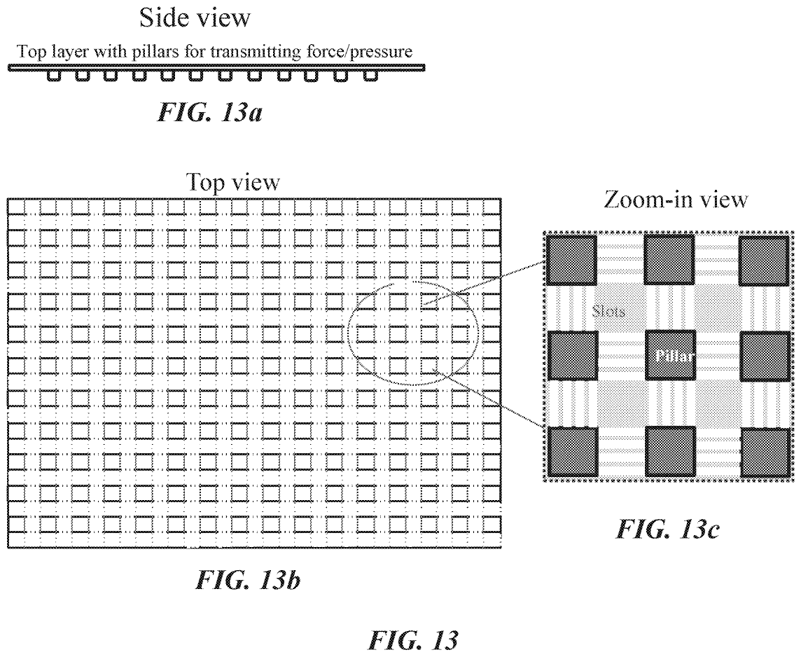

FIG. 13 shows another example of a smart skin device. FIG. 13(a) in FIG. 13 shows the side view of the top layer of an embodiment which has arrays of square shaped pillars for transmitting the force/pressure to the fiber laid on the base layer. The square shaped pillars can be molded together with the top sheet, or milled with a milling machine on a sheet of metal or plastic material, or even printed using a 3D printer. FIG. 13(b) in FIG. 13 shows the top view of the top layer with the square shaped force-transmitting pillars. In this example, the middle elastic layer described in the smart skin device in FIG. 1 is eliminated in this particular design since the pillars are already fixed in position on the top layer. FIG. 13(c) of FIG. 13 shows the zoom-in view of the top layer, in which narrow slots can be seen cut around the square pillars to make each pillar more flexible for the slight up and down motion in operation. The thickness of the top sheet may be between 0.1 to 1 mm and the height of the pillars is between 0.2 mm to 0.99 mm in some implementations.

In various implementations of smart skin devices based on the disclosed technology, an optical detection module is included and is coupled to the first terminal of the optical fiber to launch light into the optical fiber and receive backscattered light from the optical fiber for measuring the light that carries information of the localized birefringence in the fiber induced by transmitted forces by the different force sensing elements. In other implementations, the optical detection module may include an optical frequency domain reflectometer (OFDR) with polarization analysis capability for obtaining distance resolved birefringence along the optical fiber with high spatial resolution, or the optical a time domain reflectometer (OTDR) with polarization analysis capability for obtaining distance resolved birefringence along the optical fiber with high spatial resolution. In yet other implementations, the optical detection module can be designed to include a pulsed light source to generate light pulses to the optical fiber so that the returned light pulses from the optical fiber can be detected and processed to measure a spatial distribution of the force or temperature in the optical fiber based on Brillouin time domain reflectometry (BOTDR) measurements. [20, 21].

Examples of additional features of the disclosed technology for the smart robotic skin are further described below, including implementations of flexible smart skin with discrete and coupled high-density tactile sensing nodes using a single strand of optical fiber based on distributed polarization sensing. One specific design of the smart robotic skin is based on a dense array of tactile sensing nodes (e.g., up to or around 100 per cm² in some applications) using a single strand of single-mode optical fiber sandwiched between a 2D array of touching pads and a flexible substrate to sense the tactile information for enhancing robot intelligence and human-robot interactions. The implementation of this design addresses the prevalent challenges of electronic tactile sensor arrays, such as intricate wiring layouts, high energy consumption, inter-sensor crosstalk, and susceptibility to electromagnetic interference. In operation, this particular implementation of the optical sensing based sensor array for the smart robotic skin can leverage full Mueller matrix distributed polarization analysis to decode distance-resolved birefringence data along the optical fiber, translating it into precise force information at each tactile node. Experimental measurements on a prototype sample device show the sensor's excellent linear response and high sensitivity to external pressing force, with spatial resolution optimized to the millimeter scale. Notably, the system's data processing time and energy consumption were shown to be independent of the number of sensing nodes, making it attractive for high-density tactile sensing applications. Beyond tactile sensing, the same system can be extended to simultaneously sense temperature and strain, paving the way for multi-functional smart skin.

Integrating sensing capabilities into robotic applications has become a transformative approach to enhancing human-robot interaction quality and industrial efficiency.^{[22]} With advancements in the precise measurement of spatial pressure distribution, tactile sensing has become indispensable for robots, as it enables them to detect the position, time, and manner of interaction with other objects, extract useful information, and assist in environmental perception and interaction.^{[23,24]} Unlike the need for a dynamic model incorporating parameters such as torque, inertia, or acceleration for the robot's intrinsic sensors, the use of additional tactile sensors is more accurate, convenient, and offers a more generalizable approach.^{[25-27]} Flexible tactile sensors have gained widespread attention due to their higher adaptability and flexibility, enabling them to better conform to the surface shapes of robots or other objects.^{[28]} Currently, the design and implementation of many flexible tactile sensor arrays capable of multi-point measurement rely on electronic methods such as piezoelectric,^{[29,30]} resistive,^{[31,32]} triboelectric,^{[33,34]} and capacitive^{[35,36]} sensing. These tactile sensors are typically composed of multiple sensing nodes, each responsible for detecting mechanical stimuli from the surroundings and converting them into electrical signals. These signals are mapped to their corresponding sensing nodes, thereby endowing the system with perceptual capabilities.^{[37,38]} However, since most sensors connect each sensing nodes as a separate data channel, increasing the spatial resolution or sensing area of the sensor requires the integration of a large number of sensing nodes. For example, a capacitive sensor based on graphene electrodes requires at least a 6×6 array of sensing nodes to achieve a spatial resolution of 4.5 mm with a sensing area of approximately 729 mm². Each sensing node measures its own capacitance for multi-point measurement, resulting in 36 data channels. When the sensing area or spatial resolution needs to be increased, the required number of data channels becomes enormous.^{[36]} Therefore, addressing issues such as complex wiring layout, manufacturing challenges, and data processing is a major problem faced by electronic sensors in achieving multi-point, high-resolution, and large-area sensing.^{[39]}

Furthermore, as sensing systems require a constant power supply, electronic tactile sensors mostly rely on external power sources, and sensor arrays performing continuous monitoring impose significant energy demands.^{[40]} For example, a piezoresistive sensor made from three-dimensional elastic porous carbon nanotubes operates at a measurement voltage of 1V. A pressure of 2 kPa causes the power consumption of a single sensing node to reach 0.05 mW. When the pressure reaches 12 kPa, the power consumption exceeds 0.1 mW.^{[41]} This power consumption is only for the individual sensing node within the sensor and integrating the sensor array inevitably leads to additional power consumption issues, such as those arising from the connection circuits. Although combining technologies such as solar cells, flexible batteries, and supercapacitors has addressed power supply issues to some extent, each solution has its own limitations. For example, the performance of solar cells is susceptible to factors such as lighting, and environmental changes can limit the overall system efficiency and application scope.^{[42,43]} The energy density and charge/discharge performance of flexible batteries impact the long-term stability and reliability of the system.^{[44,45]} Moreover, the integration and management system of supercapacitors is complex, requiring precise control and intricate manufacturing processes.^{[46,47]} Despite the excellent performance of these sensing systems, energy consumption and the complexity of sensor array design, particularly managing the large number of wires or electrical connections for signal transmission and power supply for all the sensing nodes in the sensor array, remain significant challenges for electronic tactile sensors for achieving large-area, high-resolution sensing and spatial multi-point measurements.

The rapid development of electronic sensors has sparked research into photonic-based flexible tactile sensors. Photonic sensors, due to their small size, high sensitivity, and excellent interference resistance, are attractive for large-area, high-resolution, highly responsive, and large-scale applications in flexible tactile sensing.^{[48,49}] Optical fibers, with their ability to sense and transmit signals within the same physical channel, resistance to electromagnetic interference, electrical insulation, and excellent stability in harsh and hazardous environments, have become an attractive alternative to these challenges.^{[50]} Currently, various structures of fiber optic sensors based on Fiber Bragg Gratings (FBG) have been developed. For example, a flexible tactile sensor embedding 8 arrays of FBGs with 24 different central wavelengths is integrated into an elastomer. This sensor achieves multi-point measurements with a spatial resolution of 10 mm across a sensing area of 150×130 mm² under pressures ranging from 1 to 9N.^{[51}] Unfortunately, FBGs tend to be expensive and require a relatively large optical spectrum for each sensing element, making it difficult to integrate dense arrays, which imposes significant limitations on large-area, high-resolution multi-point tactile sensing applications.

Optical sensing based tactile sensors may be implemented by embedding a single strand of multimode fiber (MMF) into a silicone rubber substrate based on the multimode interference pattern generated by injecting light from a single-mode fiber (SMF) into the MMF. For example, such a tactile sensor system may be trained by deep learning algorithms for more accurate perception to achieve, in various implementations, a maximum sensing area of 15×15 mm², with a spatial resolution of down to 0.5 mm and a relatively small sensing force range between 0.33 to 0.59 N, with a resolution of 0.03 N.^{[50]} One limitation of this specific tactile sensor system is the lack of the ability to perform multi-point simultaneous detection. Additionally, performance degradation after multiple iterations, as well as the potential need for recalibration or retraining after certain cycles, may pose a risk to the long-term stability of the sensor.

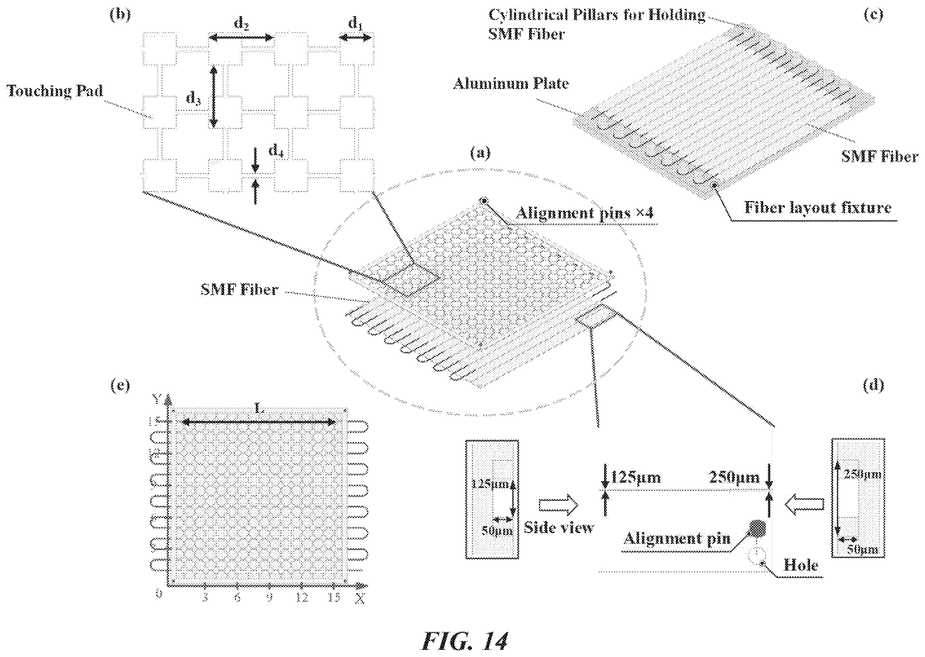

Based on the disclosed optical sensing based smart skin features in FIGS. 1-13, additional technical features for a flexible smart skin with discrete and coupled high-density tactile sensing nodes using a single strand of sensing optical fiber based on a flexible substrate for achieving two-dimensional (2D) tactile sensing are illustrated in FIGS. 14-22 using full Mueller matrix distributed polarization analysis (DPA)^{[52-54]} of light in a single-mode optical fiber (SMF). The sensing fiber is laid in a serpentine pattern, which is sandwiched between a 2D array of touching pads and a flexible substrate crafted from a thin sheet made of a stainless-steel sheet, a metal or an alloy material sheet, with each pad defining a tactile sensing node. Pressing forces applied to the touching pads induce birefringence in the underlying fiber sections via the photo-elastic effect, which is proportional to the applied force. The DPA enables us to obtain distance-resolved birefringence along the fiber,^{[53-55]} converting it to local force data at each tactile sensing node. By converting the 1D force data along the fiber into a 2D data array matching to the grids defined by the touching pads, a large-area, high density, and multi-point tactile sensor array with simultaneous force perception capability is realized.

Unlike certain designs of electronic robotic skins that use multiple data channels for sensing, the optical sensing based robotic skin designs in this patent document use a single data channel via the single strand of sensing optical fiber, simplifying wire management and reducing power consumption and inter-sensor crosstalk. Additionally, processing time and complexity remain constant regardless of the number of sensing nodes, ideal for making large area and high-density sensing arrays.

The optical sensing based smart skin designs in FIGS. 14-22 can be cost-effective, fabricated with low-cost standard single-mode fiber and thin stainless-steel sheets. Experimental measurements conducted on a constructed prototype showed a spatial resolution down to 1 mm, a high force sensitivity of 1.238×10⁻⁵ RIU/N, a minimum achievable sensing force of 3.3×10⁻⁴ N, a maximum achievable sensing force of 8.4 N, and a large dynamic range of 44 dB. This innovative approach paves the way for large-area tactile sensing skin, ideal for robotic perception, human-robot interaction, and prosthetics, among other applications.

FIG. 14 shows an example of a 2D flexible tactile sensor array fabricated using Corning SMF-28e communication SMF, which can be customized to different sizes according to the required spatial resolution and sensing area. FIG. 14(a) in FIG. 14 shows the overall 2D flexible tactile sensor array structure with three layers: the top external layer, the middle fiber layer, and the bottom substrate layer.

FIG. 14(b) of FIG. 14 shows the top external layer having a grid of multiple square touching pads with M rows and N columns fabricated with a 100 μm thick, highly flexible stainless sheet using precision laser cutting technique, creating M×N touching pads with d₁ mm sides, d₂ mm horizontal spacing, and d₃ mm vertical spacing. These touch pads are interconnected with narrow strips of d₄ mm, carved out from the same stainless-steel sheet.

The middle layer underneath the top layer touching pads implements the SMF optical fiber for optical sensing where the SMF optical fiber is laid out in a serpentine pattern and affixed on the bottom layer with the aid of a fiber layout fixture shown in FIG. 14(c) of FIG. 14. The fixture in this example is made of an aluminum plate with a row of cylindrical pillars on each side for holding each row of the fiber in the center section straight, while precisely setting the spacing between the fiber rows. The center section of the fiber in each row has its buffer removed to enhance its pressure sensitivity and consistency for the induced birefringence in response to the pressures from the touching pads, while the buffer of the fiber segments on the two ends of the sensing area remains intact for protecting them from accidental breakage. Therefore, the center sections of the fiber have a diameter of 125 μm, while the fiber sections on the two ends have a diameter of 250 μm.

The bottom layer in FIG. 14 is made with the same highly flexible material as the top layer, which is a 100 μm thick plane sheet of stainless steel with grooves chemically etched for guiding and holding the SMF fiber in place with adhesives, as shown in FIG. 14(d). Each groove has a rectangular cross section with two different widths: 250 μm at two ends for holding the fiber with buffer on the rim of the bottom sheet and 125 μm in the middle section of the bottom sheet to match the diameter of the unbuffered fiber and hold the fiber in place.

The top layer touching pad grid is placed on top of the bottom sheet with the touching pads aligned with the unbuffered fiber using four alignment pins through the four holes at the four corners of the top and bottom sheets, as shown in FIG. 14(d) of FIG. 14. The 2D sensor array structure is assembled by gluing them together with a silicon-based adhesive on the four rims of the two sheets, as shown in FIG. 14(e) of FIG. 14.

Three prototype 2D flexible tactile sensor array smart skins were constructed based on the features in FIG. 14 and were tested with various measurements. The three prototype devices were of different sizes of touching pads and different spacings between adjacent touching pads were fabricated, as shown in Table 1.

TABLE 1
Parameters of 3 fabricated prototype smart skin devices

| | | | Vertical | | |
|---|---|---|---|---|---|
| | Pad | Horizontal | node | # of | Skin |
| Device | size | node | spacing | sensing nodes | size |
| # | d₁ | spacing d₂ | node d₃ | M × N | L × W |
| 1 | 4 mm | 8 mm | 8 mm | 15 × 15 | 132 × 132 mm² |
| 2 | 2 mm | 4 mm | 4 mm | 30 × 30 | 132 × 132 mm² |
| 3 | 1 mm | 2 mm | 2 mm | 10 × 10 | 26 × 26 mm² |

In conducted tests, each touching pad receives the exerted pressing force to squeeze the unbuffered fiber segment underneath and induce a birefringence in this segment via photo-elastic effect, which can be detected with its location information along the fiber using full Mueller matrix distributed polarization analysis to be discussed in detail next.

A distributed Mueller matrix polarimetry system^{[52]} is used to perform the distributed polarization analysis to obtain the distance resolve birefringence along the optical fiber. The system incorporates a polarization state generator (PSG) and a polarization state analyzer (PSA) made with binary MO polarization rotators^{[56-58]} in an optical frequency domain reflectometry (OFDR) system to perform the distance resolve polarization measurements,^{[52]} which sometimes is called a polarization analyzing OFDR (PA-OFDR).

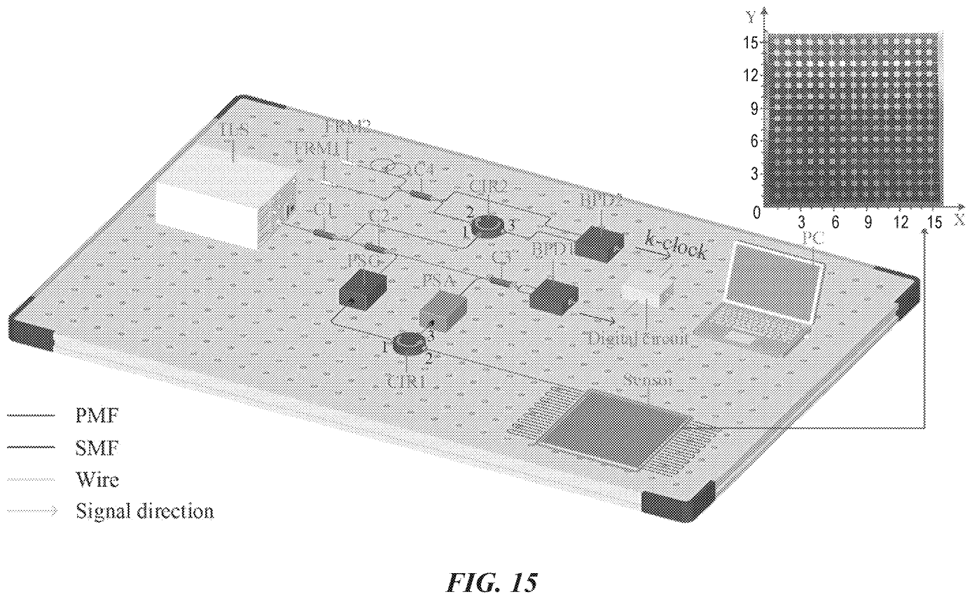

FIG. 15 shows the basic schematic of the binary DPA system used in testing the 3 prototype smart skin devices. Light from a tunable laser source (TLS, TLB-8800-L-CL Venturi, New Focus) with a long coherence length is coupled into a PM fiber PMF. Around 5% is coupled out by a first coupler C1 to a k-clock consisting of a circulator (CIR2) and a Michelson interferometer made with SMF in which two Faraday rotation mirrors (FRMs) are used to eliminate polarization fluctuations. The outputs from the interferometer are detected and amplified by a first balanced photodetector (BPD2) to get the incremental frequency of the TLS.

In the DPA system in FIG. 15 for testing each prototype 2D flexible tactile sensor array smart skin under test, the light from TLS in the polarization maintaining fiber PMF is coupled out, around 10%, by a second coupler C2 as a local oscillator (LO) beam. The remaining light first goes through a PSG and is then directed into the SMF in the prototype 2D flexible tactile sensor array smart skin via another circulator (CIR1). The back scattered and reflected light from the SMF in the prototype 2D flexible tactile sensor array smart skin is directed to port 3 of CIR1 and then goes through a PSA before entering a PM fiber to be mixed at a third coupler C3 with the LO beam from C2. The interference signals from two outputs of C3 are detected and amplified by a second balanced detector (BPD1), and the output of BPD1 is finally sent to the analog to digital converter (ADC) on the digital circuit board to be converted to digital signal with 16-bit resolution. The zero crossings of the interference signal from the k-clock interferometer detected by BPD2 are converted to trigger pulses in the digital circuit to trigger the ADC so that the signal from BPD2 is digitized with equal frequency spacing. The working principle of the k-clock and the data processing algorithm can be found in detail in.^{[59-60]} Fast Fourier transform (FFT) of the digitized signal then reveals the location information of backscattered and reflected light originating at different locations in the prototype 2D flexible tactile sensor array smart skin.

For each input SOP generated by the PSG, the SOP of the reflected or back scattered light wave at any point along the fiber can be precisely measured using PSA in the system.^{[52-55]} By generating 4 distinctive input SOPs with the PSG and analyzing the corresponding SOPs of reflected or back scattered light at each point along the optical path for each input SOP with the PSA, the Mueller matrix at each point in the optical fiber can be obtained. Consequently, the birefringence Δn(z) of the optical medium at each point along the optical path can be derived. Because of the high speed (~20 μs) and high repeatability advantages of the binary PSG and PSA, this binary DPA is also capable of high speed and high accuracy in obtaining both the SOP distribution and the birefringence distribution along the optical fiber. The local birefringence Δn(z) can be obtained as^{[52,53]}

$$Δ n ( z ) = \frac{θ ( z ) λ}{4 π Δ z} \qquad ( 11 )$$

where θ(z) is the retardation caused by local birefringence in the sensing optical fiber, λ is the center wavelength of the scanning range, and Δz is the length of the fiber segment used to calculate the retardation, which is called birefringence spatial resolution (BSR). With the local birefringence obtained, the local transverse or lateral force can be determined because it is linearly proportional to the birefringence via the photo-elastic effect and can be expressed as:^{[52,54]}

$$Δ n = \frac{4 {n}^{3}}{π E Δ l} ( 1 + σ ) ( {p}_{12} - {p}_{11} ) ( \frac{F}{d} ) = η F \qquad ( 12 a )$$

where n is the refractive index of the fiber core, p₁₁ and p₁₂ denote the strain-optical coefficients, d is the fiber cladding diameter, σ is the Poisson's ratio, E is the Young's modulus, F is the transversal force applied to a fiber segment with a length of Δl (the touch pad length here), and the proportion constant η relating F and Δn is the force to birefringence conversion coefficient or in short the force measurement sensitivity (FMS):

$$η = \frac{4 {n}^{3}}{π dE Δ l} ( 1 + σ ) ( {p}_{12} - {p}_{11} ) \qquad ( 12 b )$$

Taking the parameters of fused silica: n≈1.46 at 1550 nm, E=6.5×10¹⁰ N/m², p₁₁=0.12, p₁₂=0.27 and σ=0.17, for a SMF with a cladding diameter d=125 μm, the quantity η×Δl can be estimated to be 8.559×10⁻⁸ RIU/N.

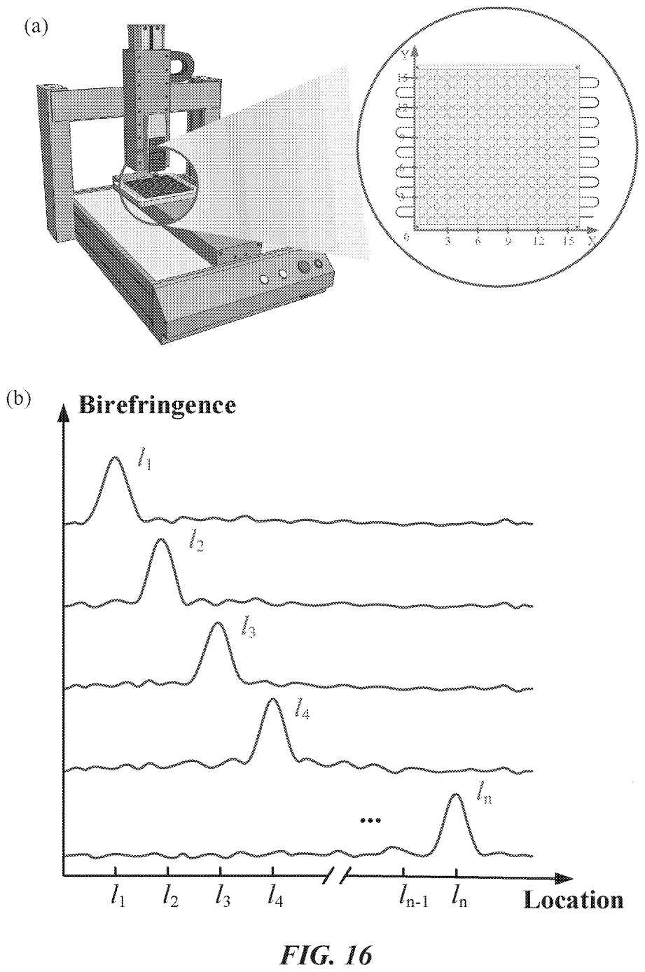

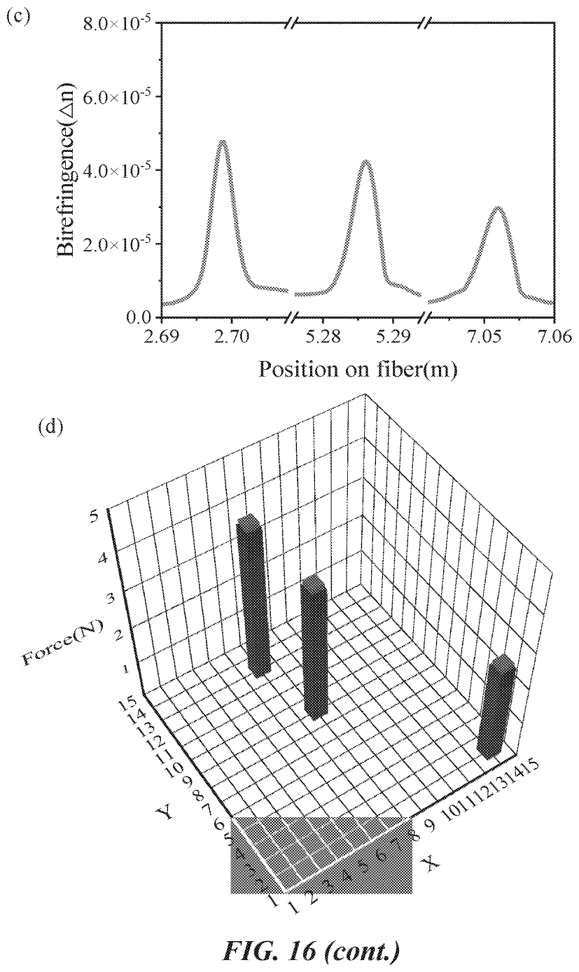

FIG. 16 shows the mapping of the fiber distances to the sensing node coordinates in testing one the prototype smart skin devices. As shown in FIG. 16(a) of FIG. 16, the location of each touching pad or sensing node can be uniquely determined by a coordinate index (i, j), where i and j are the integer numbers to locate the sensing node counted along the horizontal (X) and vertical (Y) axes of the 2D Cartesian coordinate system. The DPA system described in FIG. 15 has the ability to obtain the magnitude of a pressing force detected at an arbitrary sensing node as a function of distance along the optical fiber, however, it is necessary to convert this 1D distance information along the fiber into the 2D coordinate index (i, j) in practice. One straightforward method to do such a conversion is to press each touching pad one by one, and then match the coordinate index (i, j) of each touching pad with the corresponding distance reading from the result obtained by the DPA system. A look up table can then be tabulated which maps the distance of each sensing node along the fiber to the corresponding coordinate index (i, j). In conducted tests, a motorized 3-axis translation platform with a force gauge (DFG, Sundoo Instrument, model SH-50) was used to perform such 1D position to 2D coordinate index mapping, as shown in FIG. 16(a). In operation, the platform was programmed to move the force gauge in the XY plane to the first touching pad with a coordinate index of (1,1) before the force gauge was moved down by the Z stage to apply a predetermined force on the pad to induce a birefringence in the fiber beneath it, which was detected by the DPA system with its peak location l₁ along the fiber also determined. This peak location was mapped to the coordinate index of the touching pad [l₁→(1,1)], as shown in FIG. 16(b) of FIG. 16. By repeating the process to all the touching pads sequentially, the complete 1D to 2D conversion lookup table was tabulated and stored in the computer for future use.

When one or more forces are detected at different fiber distances with the DPA, the corresponding coordinate indices on the smart skin device can be determined using the lookup table. For example, when three pressing forces are applied to touching pads on the smart skin device, a birefringence vs. fiber distance curve shown in FIG. 16(c) of FIG. 16 can be obtained using the DPA. By searching the lookup table and matching the fiber distances with the coordinate indices, the positions of the pressures on the smart skin device can be determined to be (7,13), (8,9) and (14,2), as shown in FIG. 16(d) of FIG. 16. In practice, when the center position of the detected birefringence in terms of fiber distance l is not exactly matched to any of the coordinates, the closest matched index will be selected.

Sensitivity is a key parameter reflecting the performance of the sensor array. Using the DPA system, the relationships between pressing force F applied to several randomly selected touching pads in the tactile sensor array smart skin device and the induced birefringence Δn of the SMF segment underneath them are measured and averaged to determine the force measurement sensitivity (FMS) η of the sensor array defined by Eq. (12b).

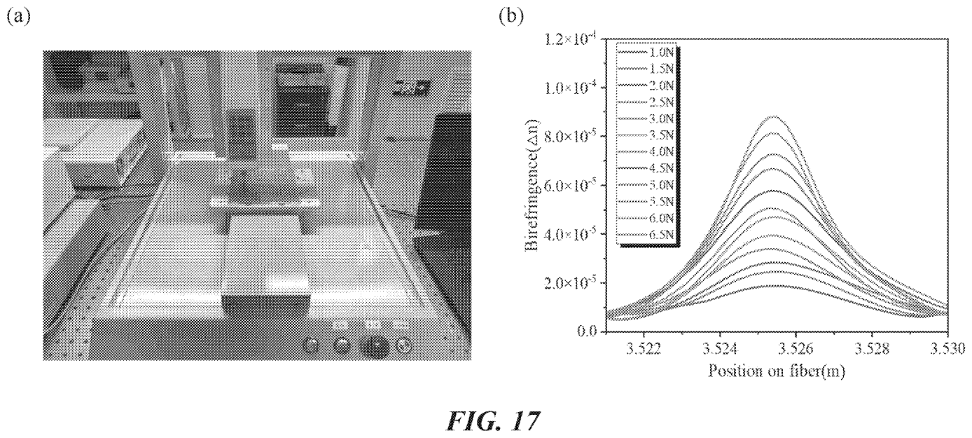

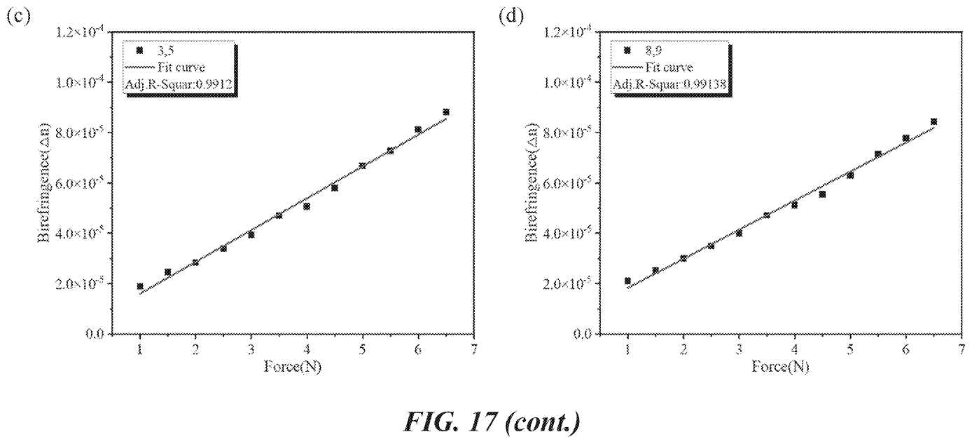

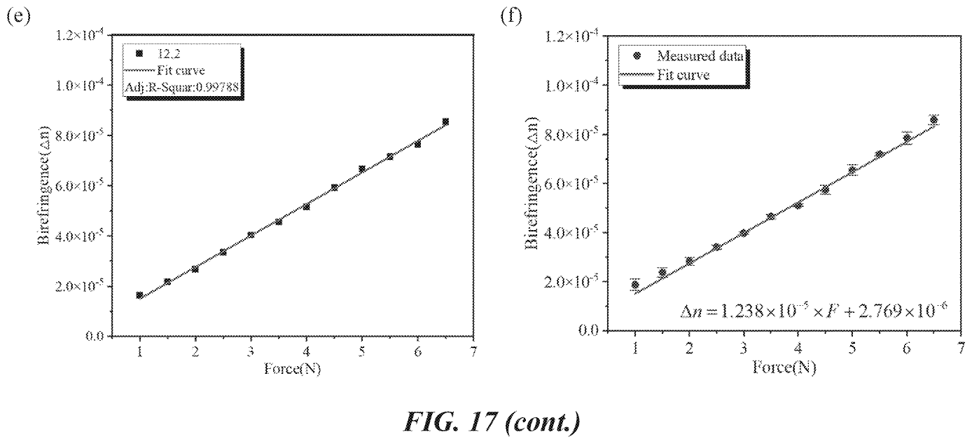

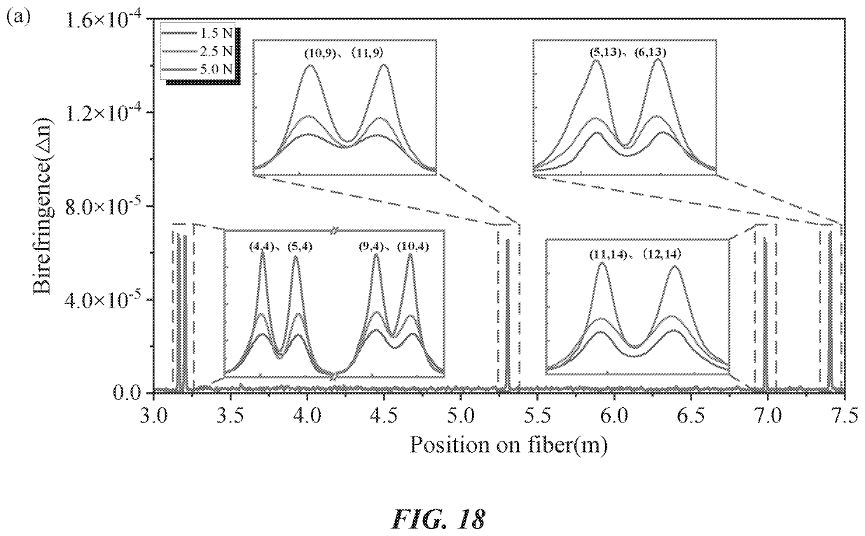

FIG. 17 shows conducted force measurement sensitivity calibration. As shown in FIG. 17(a) of FIG. 15, a motorized three-axis (XYZ) translation platform with the digital force gauge mounted on the Z axis was used to apply a series of predetermined forces to the touching pad. The prototype smart skin device #1 was selected for this measurement, which is fixed on the XYZ motorized platform with a transparent tape.

FIG. 17(b) of FIG. 17 shows the birefringence values Δn of the fiber segment underneath touching pad (3,5) corresponding to the fiber segment centered at 3.5255 m, under different applied forces. Birefringence measurements with applied forces ranging from 1 to 6.5 N with a step size of 0.5 N were taken and repeated five times for averaging at each pressing force level to reduce uncertainty. To better illustrate the details of the measured birefringence curves, the display range in FIG. 4(b) of FIG. 4 is limited to 9 mm. It can be observed that the birefringence at the corresponding fiber location increases monotonically with increasing force. The peak values of the birefringence curves under different forces, which can be used to represent the force-induced birefringence, were extracted from the data in FIG. 17(b) of FIG. 17 and displayed in FIG. 17(c) of FIG. 17. The curve fit shows a linear relationship between birefringence and applied force, with the slope being the force measurement sensitivity (FMS). Additionally, to verify the consistency of the FMS of different sensing nodes on the sensor array, two other touching pads located at (8,9) and (12,2) are selected to repeat the same measurements as those at (3,5). The peak values of the birefringence curves were similarly extracted and linearly fitted, with the results shown in FIG. 17(d) of FIG. 17 and FIG. 17(e) of FIG. 17. It can be seen from the two figures that the birefringence in the fiber segments for each sensing node exhibits an excellent linear relationship with the applied force of similar slopes. The average slope, which is the FMS, is obtained to be 1.238×10⁻⁵ RIU/N, as shown in FIG. 17(f) of FIG. 17.

In FIG. 15, the tunable laser (New Focus TLB-8800-L-CL) has a linewidth about 40 times of that (Yenista T100S-HP)^{[54,61]} used in our previous experiment on transverse force sensing, resulting a much higher system noise floor than that in our previous experiments^{[54}]. Therefore, the experimental data in [54] with a narrower linewidth tunable laser can be used to obtain the minimum and maximum detectable pressing forces. The FMS can be approximately doubled if the narrower linewidth tunable laser in [54] is used.

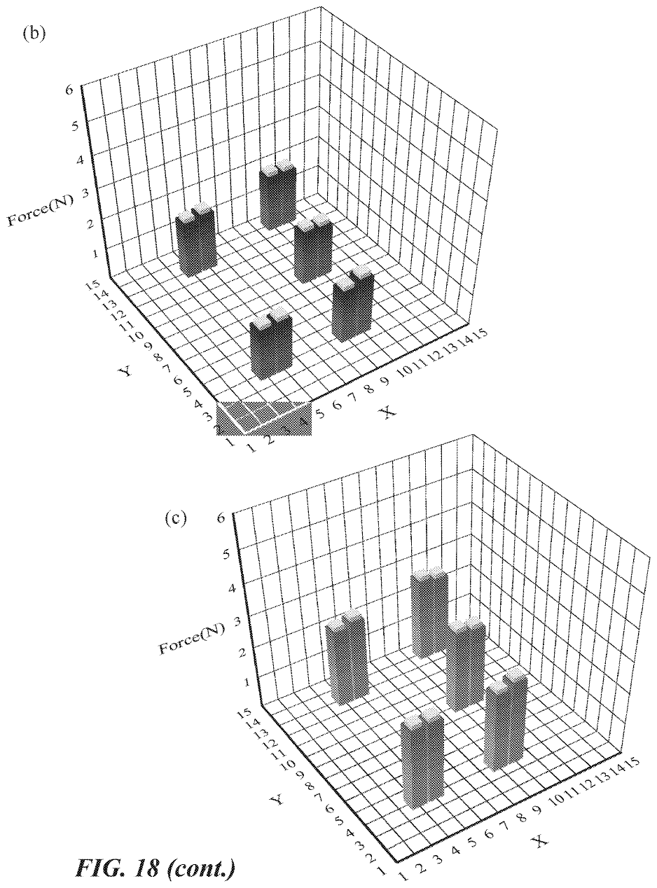

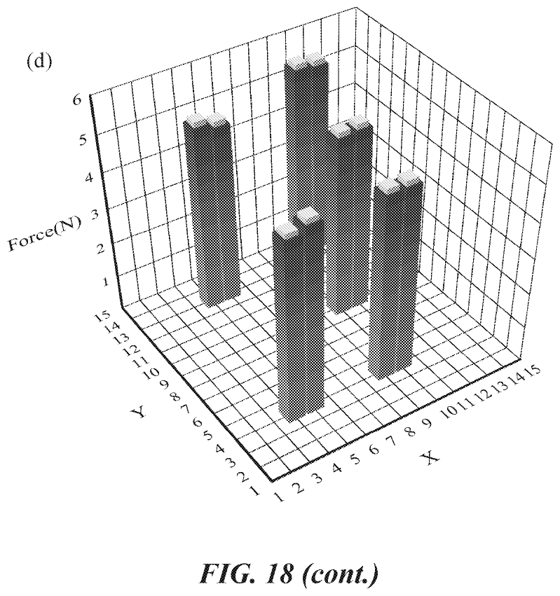

The spatial resolution of the prototype smart skin devices was also tested. The spatial resolution of the sensor is determined by the spacing d₂ of the sensing nodes in the upper layer or the birefringence resolution of the DPA system, whichever is larger, which can be determined experimentally. Measurements were evaluated on prototype device #1 with d₁ of 4 mm and d₂ of 8 mm. Five pairs of adjacent touching pads, (4,4) and (5,4); (9,4) and (10,4); (10,9) and (11,9); (5,13) and (6,13); (11,14) and (12,14), are randomly selected on the sensor array for birefringence measurement. First, a weight of 3 N is placed onto each pair of touching pads simultaneously to induce five pairs of birefringence peaks along the fiber from 3 m to 7.5 m, as shown by the black curves in FIG. 18, followed by a weight of 5 N, and finally a weight of 10 N, to induce five corresponding pairs of birefringence peaks, as shown by the red and blue curves, respectively. Because two touching pads shared a single weight, the effective weights on each pad are 1.5, 2.5, and 5 N, respectively. The insets in FIG. 18(a) provide detailed views of the double birefringence peaks induced by the weights on the five pairs of the touching pads at five locations along the fiber. It is evident that our DPA system can clearly resolve the double peaks separated by 8 mm by naked eyes and therefore has a spatial resolution better than 8 mm.

The peak values of each birefringence curve in the insets of FIG. 18(a) can be converted to the forces detected at each sensing node. The peak-to-peak spacings represent the spacing between the two sensing nodes where the force is applied. The locations of the birefringence peaks and the spacings between the double peaks of the five pairs of sensing nodes are summarized in Table 2.

TABLE 2
Measured Peak Locations and Peak-to-Peak Spacings for
Five Sets of Data with Different Pressing Forces

| | 1.5N | | | 2.5N | | | 5.0N | | |
|---|---|---|---|---|---|---|---|---|---|
| | Peak1 | Peak2 | | Peak1 | Peak2 | | Peak1 | Peak2 | |
| | Location | Location | Spacing | Location | Location | Spacing | Location | Location | Spacing |
| Group | (mm) | (mm) | (mm) | (mm) | (mm) | (mm) | (mm) | (mm) | (mm) |
| A | 3160.45 | 3168.49 | 8.04 | 3160.25 | 3168.49 | 8.24 | 3160.45 | 3167.88 | 7.43 |
| B | 3200.83 | 3209.07 | 8.24 | 3201.03 | 3208.66 | 7.63 | 3200.83 | 3208.45 | 7.62 |
| C | 5301.00 | 5308.62 | 7.62 | 5301.00 | 5308.83 | 7.83 | 5301.20 | 5309.24 | 8.04 |
| D | 6979.28 | 6987.52 | 8.24 | 6979.28 | 6987.31 | 8.03 | 6979.49 | 6987.73 | 8.24 |
| E | 7401.99 | 7410.23 | 8.24 | 7401.79 | 7409.41 | 7.62 | 7401.79 | 7409.61 | 7.82 |

Table 2 shows that the measured spacings of the five pairs of double peaks agreed well with the actual physical spacing (8 mm) between each pair of adjacent touching pads for all three levels of applied forces, with a maximum deviation of only 0.57 mm. Meanwhile, the errors in the peak locations along the fiber under different forces are much smaller than half of the node spacing for accurately mapping the fiber distance to the sensing node coordinates.

FIGS. 18(b)-(d) of FIG. 18 show the three-dimensional (3D) presentation of measured forces at five pairs of sensing nodes under applied forces of 1.5 N, 2.5 N, and 5.0 N, respectively.

Spatial resolution enhancement by curve-fitting: It can be seen from the insets of FIG. 18(a) of FIG. 18 that the force induced birefringence curves have a shape and width determined by the birefringence resolution of the DPA system^{[52]}. When the spacing d₂ between two adjacent sensing nodes are closer than the width of the birefringence curve, the two corresponding peaks may no longer be distinguishable by naked eyes. However, the two peaks can still be separated digitally by curve-fitting, in which the shape function of the birefringence curve must be determined first.

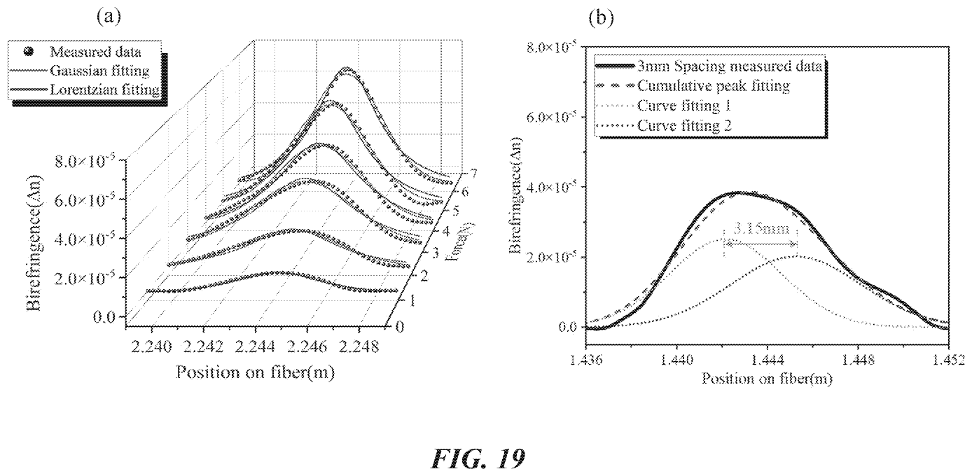

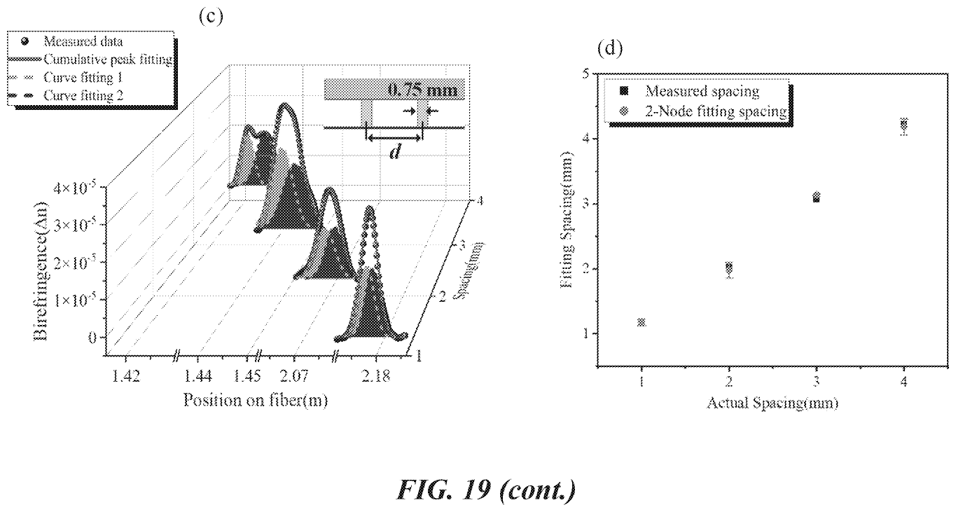

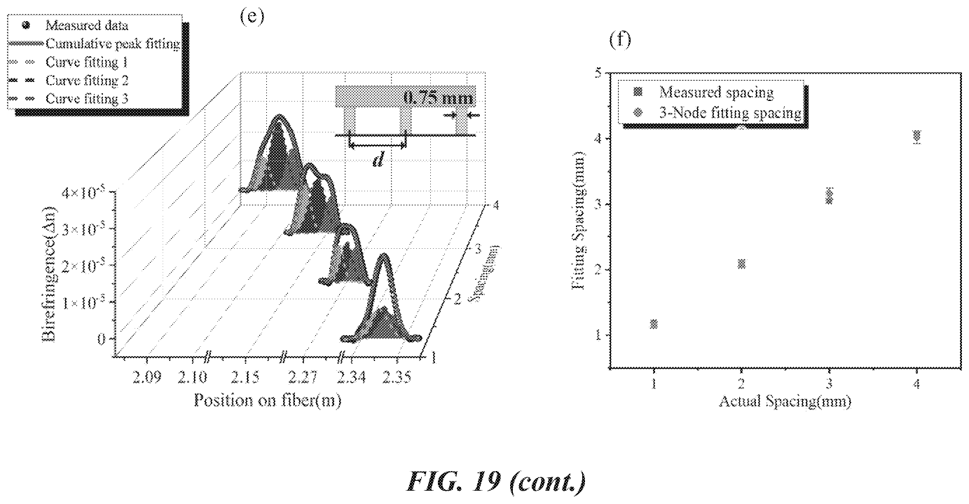

FIG. 19 shows validation of the spatial resolution enhancement using the curve fitting method. FIG. 19(a) of FIG. 19 shows the birefringence curves of a randomly selected sensing node subjected to different applied weights from 1.0 N to 6.0 N with a step size of 1.0 N, which are fitted to both Gaussian and Lorentzian functions. It can be seen that the Gaussian function provides a better fit (red curve) across all force levels, while the Lorentzian function (blue curve) performs relatively poorly at the tails of the curves. Therefore, the Gaussian function is chosen as the fitting function for subsequent curve fitting analysis, which can be written as:

$$Δ n ( l , F ) = δ {n}_{0} + Δ n ( F ) {e}^{- \frac{{( l - {l}_{i , j} )}^{2}}{{ω}^{2}}} \qquad ( 13 )$$

where δn₀ is the residual birefringence in the fiber, Δn(F) is the amplitude of force induced birefringence, l is the distance along the fiber, l_{i,j} is the peak location of the Gaussian birefringence curve induced by the force applied on the sensing node (i, j) along the fiber, and 2ω is the 1/e width of the Gaussian curve which is a constant regardless the force applied, because the widths of the Gaussian curves induced by different forces at different sensing nodes are the same.

When the spacing between two sensing nodes is less than the Gaussian width 2ω, the combined birefringence curve may appear distorted, no longer resembling a Gaussian shape, as shown in FIG. 19(b) of FIG. 19. One may obtain the underlying two Gaussian curves by fitting the measured data Δn_{c}(l) to the superposition of two Gaussian functions of different amplitudes and at different peak locations using:

$$Δ {n}_{c} ( l ) = δ {n}_{0} + Δ {n}_{1} {e}^{- \frac{{( l - {l}_{1} )}^{2}}{{ω}^{2}}} + Δ {n}_{2} {e}^{- \frac{{( l - {l}_{2} )}^{2}}{{ω}^{2}}} \qquad ( 14 )$$

where the four parameters, Δn₁, Δn₂, l₁ and l₂, are to be determined from curve fitting. As shown in FIG. 19(b), the superposition (dashed red) of two Gaussian curves (dotted green and blue) separated by 3.15 mm matched well with the measured birefringence curve (solid black). The 3.15 mm separation agrees well with the 3.07 mm spacing of the double-bump force applying fixture measured with a vernier caliper.

To further explore the resolution enhancement capability of the curve fitting method, we fabricated, using a 3D printer, three more double-bump force applying fixtures, with different spacings at 1 mm, 2 mm and 4 mm, respectively, as shown in the inset of FIG. 19(c) of FIG. 19. These double-bump fixtures were used to induce different birefringence distributions in the fiber, as shown in FIG. 19(c). Using the curve-fitting method described above, each measured birefringence curve can be represented as the superposition of two Gaussian curves, with the spacing well matched to the corresponding spacing between the two force-applying bumps, as shown in FIG. 19(d) of FIG. 19. Corresponding to the bump spacing of 1 mm, 2 mm, and 4 mm, the obtained Gaussian peak separations are 1.17 mm, 1.98 mm, and 4.18 mm, respectively, agreeing reasonably well with the spacings of the bumps for generating the birefringence distributions.

Similarly, to obtain the locations and amplitudes of M underlying Gaussian shaped birefringence curves induced by forces applied to M consecutive sensing nodes with spacing less than the width of the Gaussian function, the measured birefringence data Δn_{c}(l) can be fitted to the superposition of M Gaussian functions of different amplitude Δnᵢ and peak locations lᵢ as:

$$Δ {n}_{c} ( l ) = δ {n}_{0} + {\sum }_{1}^{M} Δ {n}_{i} {e}^{- \frac{{( l - {l}_{i} )}^{2}}{{ω}^{2}}} \qquad ( 15 )$$

FIG. 19(e) of FIG. 19 shows the curve fitting results (red) of the birefringence distribution data (black) induced by closely spaced triple-bump fixtures of different spacings at 1 mm, 2 mm, 3 mm, and 4 mm, in which the underlying Gaussian curves (green, blue and purple) obtained from curve fitting to Eq. (15) (M=3) can be seen, which yield spacings between the peaks at 1.15 mm, 2.09 mm, 3.17 mm, and 4.02 mm.

FIG. 19(f) of FIG. 19 shows the comparison of the obtained spacings and the actual bump spacings, indicating excellent agreement. The results demonstrate that the spatial resolution of the sensor array can be greatly improved beyond the limit imposed by the single-point resolution of our DPA system.

In a previous study^{[54]} in our lab, a detailed investigation of the capabilities of our DPA system in detecting the transversal line force applied to a segment of optical fiber was conducted. The minimum detectable line force is limited by the residual birefringence (RB) in the optical fiber, which was found to have a value of around 1.325×10⁻⁷ in selected sections of optical fibers with lowest RB. The minimum detectable line force was defined as the force that can induce a birefringence twice of the RB, which was measured to be 6.61×10⁻⁴ N/mm. Taking the width of the touching pad to be 1 mm, the minimum detectable force is 6.61×10⁻⁴ N or 0.068 grams.

To achieve such minimum detectable force in all fiber sections, the RB in the fiber needs to be further reduces, which can be achieved by thermal annealing^{[62]} or alternatively by improving the fiber manufacturing process. For example, as early as 1979, single mode fiber with extremely low retardation of 2.6°/m was fabricated^{[63]}, corresponding to an average birefringence of 10⁻⁸. It is expected that the worst RB in such a fiber is on the order of 10⁻⁷ to claim the minimum detectable force of 0.068 grams.

The maximum detectable line force was also measured in our previous study^{[54]}, which was found to be 16.8 N/mm. Again, taking the width of the touching pad to be 1 mm, the maximum detectable force is 16.8 N or 1.71 kg. Corresponding to the minimum detectable forces of 0.068 grams, the achievable force detection dynamic range is 44 dB. Table 3 summarizes the spatial resolution, the minimum and maximum touching force, and node density achievable with our approach, assuming a node spacing of 1 mm and a touching pad width of 0.5 mm.

TABLE 3
DPA enabled smart skin's achievable performance parameters

| | | Min. | Max. | |
|---|---|---|---|---|
| | Spatial | touching³³ | touching³³ | Node |
| | resolution | force (N) | force (N) | density |
| Achievable assuming a | 1 mm | 3.3 × 10⁻⁴ | 8.4 | 100/cm² |
| node spacing of 1 mm | | | | |
| and a touching pad | | | | |
| width of 0.5 mm | | | | |

In conducted tests, five pairs of sensing nodes with a spacing of 8 mm for each pair on the prototype smart skin device #1 were subjected to three different force levels. The tested prototype sensor array smart skin device successfully identified the locations and magnitudes of the applied forces at 10 sensing nodes.

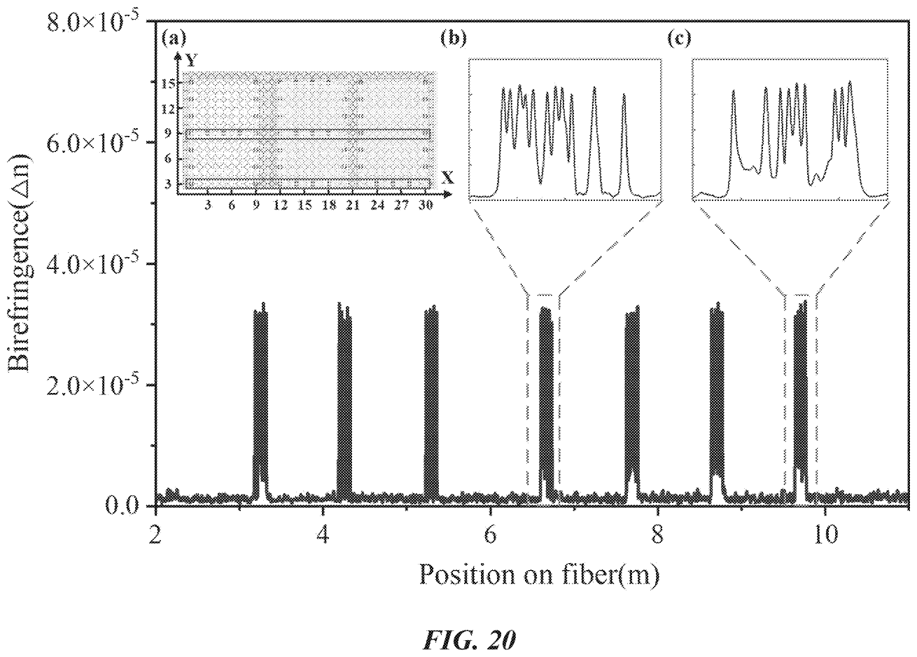

Tests were also conducted for the prototype sensor array smart skin device #2 with 52 sensing nodes to demonstrate the ability of tactile sensing over a larger area and involving a large number of sensing nodes by applying a weight of approximately 3N on each node. FIG. 20 shows measurements of 2D tactile sensing over a large area and involving a prototype smart skin device #2 with 52 sensing nodes. To ensure uniform force distribution on each node, three letter-shaped fixtures resembling HBU (abbreviation for Hebei University) were fabricated for weight loading on the device #2 as shown in the inset (a) of FIG. 20. The blue curve in FIG. 20 shows the 1-dimensional distribution data of the changes in the birefringence at different locations along the fiber obtained with DPA. Inset (a) is the deice #2 with weight loading letters HBU on top. Insets (b) and (c) are the zoom-in views of the local birefringence distribution in response to the weight applied to the sensing nodes in rows 3 to 15, respectively, which demonstrate the effectiveness of the sensor array for identifying the locations along the fiber and obtaining the magnitudes of the forces exerted on the sensing nodes for 2D tactile sensing.

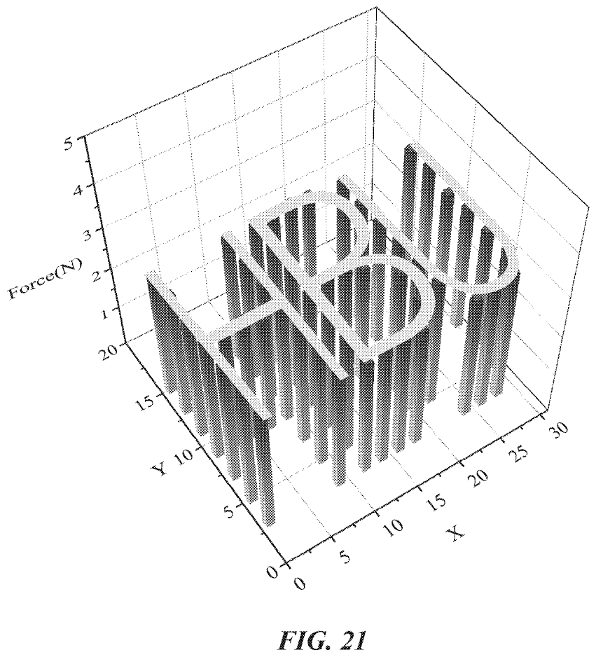

FIG. 21 shows the 3D presentation of the data in FIG. 20 for the device #2 after converting the 1D coordinate of the sensing nodes along the fiber to the 2D coordinate indices on the device #2, showing the magnitudes and locations of the forces detected.

The smart skin design in FIG. 14 uses a thin straight strip to interconnect different touch pads as shown in FIG. 14(b) of FIG. 14. For various tactile sensing applications including robotic devices or systems, the sensing smart skin needs to have built-in stretchability to deform in shape when interacting with external objects and sensing interactions with the external objects. One way to provide such stretchability to allow the smart skin device to deform is implement stretchable interconnects between different touch pads.

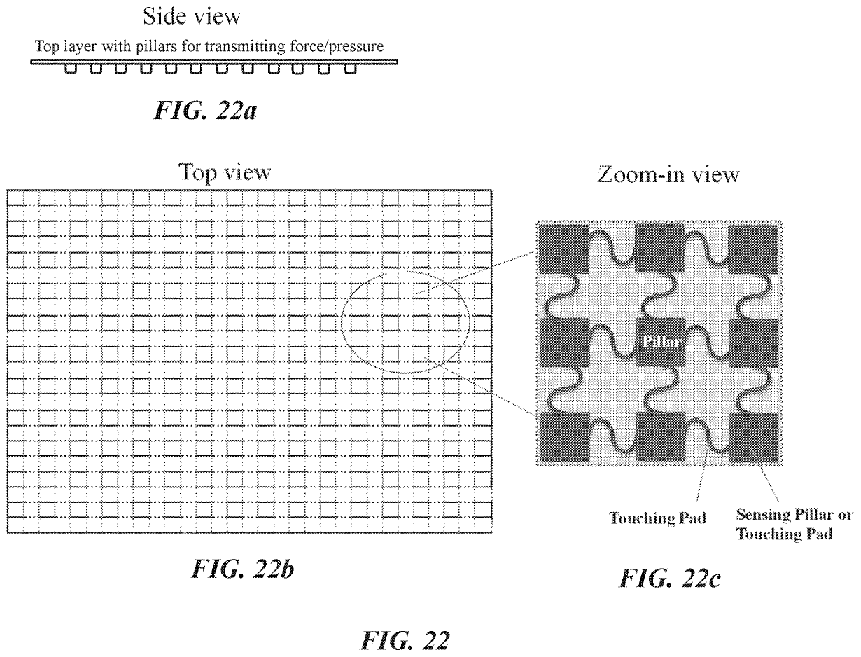

FIG. 22 shows one example of such a stretchable interconnect design. FIG. 22(a) of FIG. 22 shows the side view of the top layer of an embodiment which has arrays of square pillars or square touching pads for transmitting the force/pressure to the fiber laid on the base layer. The pillars or pads can be molded together with the top sheet, or milled with a milling machine on a sheet of metal or plastic material, or even printed using a 3D printer. FIG. 22(b) of FIG. 22 shows the top view of the top layer with the square force-transmitting pillars or pads. FIG. 22(c) of FIG. 22 shows the zoom-in view of the top layer, in which the pillars or touching pads are connected with curved or wiggling interconnect lines to allow a certain amount of stretchability. The curved wiggling interconnect lines can be made by chemical etching or laser cutting.

The above disclosure of the examples in FIGS. 14-22 can be used to provide an optical smart skin for 2D tactile sensing using a single strand of single-mode optical fiber in a serpentine pattern and sandwiched between a touching pad array and a flexible stainless-steel substrate, for large-area, high-resolution, simultaneous multi-point sensing. A touching/pressing force on the fiber induces local birefringence proportional to the force via the photo-elastic effect, detected through distributed polarization analysis. Multiple touching/pressing forces on different fiber segments can be detected simultaneously without mutual interference, enabling multi-point sensing. The fiber distance data is mapped to 2D coordinates for 3D visualization of local pressing forces.

Unlike certain traditional electronic tactile sensor arrays that need numerous electrical connections, our approach uses a single strand of optical fiber, which serves as both multiple sensing elements and a data channel, simplifying design and manufacturing while reducing energy consumption. Additionally, the power consumption and the data processing time remain fixed regardless of the number of sensing nodes, making it suitable for large sensor arrays.

The prototype sensor array smart skin devices were tested and showed excellent linear response and high sensitivity, consistently outputting clear signals under various pressing forces. Using the curve fitting method we developed; the spatial resolution can be improved to 1 mm for high-density multi-point sensing. As an example, assuming 1 mm spacing between adjacent sensing nodes, a density of 100 nodes per cm² can be achieved. The maximum number of nodes exceeds 10,000, based on a fiber length of 100 m.^{[54]}

Additional improvements can be made for implementing the disclosed technology for various practical applications. First, as ab example, the current DPA measurement time of 50 seconds is too slow; enhancing the tunable laser's frequency scanning speed could reduce response time to 0.2 seconds or less for real-time sensing. Second, the size and cost of the current DPA system can be significantly reduced via photonics integration^{[64]}, considering that the interferometer, the k-clock generator, the PSG, and PSA in a DPA system can all be fabricated on a thin film lithium niobate based photonic integrated circuit^{[65,66]}. Third, the sensitivity in measuring touching/pressing forces can be more than doubled in principle by replacing current 125 μm diameter fiber with 60 μm diameter fiber, according to Eq. (12). Fourth, residual birefringence in the fiber limits the minimum detectable force, which can be reduced through fiber annealing or manufacturing process improvements. Fifth, optimizing the mechanical structure of the o-skin can enhance conformity and fixation to robotic surfaces. Sixth, optimizing software for signal processing and data visualization will meet real-time and accuracy needs in large-scale multi-point tactile sensing. Furthermore, in addition to tactile sensing, the same DPA system, which inherited all the capabilities of an OFDR, can be used to simultaneously sense temperature and strain with millimeter scale resolution^{[67,68]} with a corresponding data processing software to enable multi-functional smart skin. The DPA based tactile sensing is expected to achieve a spatial resolution down to 1 mm, a sensing node density up to 100/cm², a minimum detectable force of 3.3×10⁻⁴ N, a maximum detectable force of 8.4 N, and a large dynamic range of 44 dB, sufficient for sensing touching and pressing sensations.

In essence, the disclosed SMF-based optical sensing smart skin devices represent a significant leap forward in smart skin research, boasting a simple structure, high-density sensing nodes, extensive coverage, low energy consumption, and enhanced performance, all while reducing system complexity. Beyond tactile sensing, the disclosed technology may be implemented to simultaneously detect temperature and strain, paving the way for diverse applications in robotic perception, human-robot interaction, prosthetics, healthcare, wearable technology, smart infrastructure, structural health monitoring, and machine automation. By elevating tactile perception and sensory accuracy, this advanced form of smart skin is poised to revamp human-robot interaction technology and stimulate more groundbreaking innovations.

### REFERENCES

1. T. Feng, Y. Shang, X. Wang, S. Wu, A. Khomenko, X. Chen and X. S. Yao, Distributed polarization analysis with binary polarization rotators for the accurate measurement of distance-resolved birefringence along a single-mode fiber. Opt. Express 26(20): pp. 25989-26002 (2018).
2. T. Feng, J. Zhou, Y. Shang, X. Chen and X. S. Yao, Distributed transverse-force sensing along a single-mode fiber using polarization-analyzing OFDR. Opt. Express 28(21): pp. 31253-31271 (2020).
3. Z. Ding, T. Liu, Z. Meng, K. Liu, Q. Chen, Y. Du, D. Li and X. S. Yao, Improving spatial resolution of optical frequency-domain reflectometry against frequency tuning nonlinearity using non-uniform fast Fourier transform. Review of Scientific instruments. 83(6): pp. 066110 (2012).
4. Z. Ding, X. S. Yao, T. Liu, Y. Du, K. Liu, J. Jiang, Z. Meng, and H. Chen, Compensation of laser frequency tuning nonlinearity of a long range OFDR using deskew filter. Opt. Express. 21 (3): pp. 3826-3834 (2013).
5. X. S. Yao, L. Yan and Y. Shi, Highly repeatable all-solid-state polarization-state generator. Opt. Lett. 30(11): pp. 1324-1327 (2005).
6. X. S. Yao, X. Chen and L. Yan, Self-calibrating binary polarization analyzer. Opt. Lett. 31(13): pp. 1948-1950 (2006).
7. A. M. Smith, Birefringence induced by bends and twists in single-mode optical fiber. Appl. Opt. 19(15): pp. 2606-2611 (1980).
8. A. M. Smith, Single-mode fibre pressure sensitivity. Electron. Lett. 16(20): pp. 773-774 (1980).
9. X. Chen and X. S. Yao, Measuring distributed polarization crosstalk in polarization maintaining fiber and optical birefringence material. U.S. Pat. No. 8,599,385, filed 14 May 2010, issued 3 Dec. 2013.
10. Z. Li, X. S. Yao, X., Chen, H. Chen, Z. Meng, and T. Liu, Complete Characterization of Polarization-Maintaining Fibers Using Distributed Polarization Analysis. J. Lightwave Technol. 33 (2): pp. 372-380 (2015).
11. T. H. Chua and C. L. Chen, Fiber polarimetric stress sensors. Appl. Opt. 28(15): pp. 3158-3165 (1989).
12. H. Zhang, Y. Wang, G. Wen, D. Jia and T. Liu, Frequency demodulation of dynamic stress based on distributed polarization coupling system. J. Lightw. Technol. 36(11): pp. 2094-2099 (2018).
13. D. Ding, T. Feng, Z. Zhao, H. Su, Z. Li and X. S. Yao, Demonstration of distributed fiber optic temperature sensing using polarization crosstalk analysis,” in Conference on Lasers and Electro-Optics (Optical Society of America, San Jose, California, 2016), p. JTu5A.105 (2016).
14. X. S. Yao, Measurements of strain, stress, and temperature by using 1-dimensional and 2-dimensional distributed fiber-optic sensors based on sensing by polarization maintaining fiber of distributed polarization crosstalk distribution. U.S. Pat. No. 9,476,699: filed 5 Mar. 2015, issued 25 Oct. 2016.
15. Hao, Peng, et al., PM fiber based sensing tapes with automated 45° birefringence axis alignment for distributed force/pressure sensing, Optics Express, 28 (13), pp. 18829-18842 (2020).
16. U.S. Pat. No. 7,027,198B2, Generation and analysis of state of polarization using tunable optical polarization rotators.
17. U.S. Pat. No. 7,265,836B1, In-line optical polarimeter using free-space polarization sampling elements.
18. U.S. Pat. No. 7,436,569B2, Polarization measurement and self-calibration based on multiple tunable optical polarization rotators.
19. U.S. Pat. No. 7,466,471B2, Optical instrument and measurements using multiple tunable optical polarization rotators. 7,466,471
20. Qing Bai et al, “Recent Advances in Brillouin Optical Time Domain Reflectometry,” in Sensors 2019, 19, 1862; https://www.mdpi.com/1424-8220/198/1862
21. Jian Fang et al., “Single-shot distributed Brillouin optical time domain analyzer,” Vol. 25, No. 13|26 Jun. 2017|OPTICS EXPRESS 15188,
22. S. Liu, W. Guo, H. Chen, Z. Yin, X. Tang, Q. Sun, Small 2024, 2405520.
23. S. Lee, J. I. Kim, Y. Baek, D. Chang, J. Lee, Y. S. Park, D. Lee, Y.-L. Park, IEEE Trans. Robot. 2024, 40, 2373.
24. H. Hu, C. Zhang, X. Lai, H. Dai, C. Pan, H. Sun, D. Tang, Z. Hu, J. Fu, T. Li, P. Zhao, npj Flex Electron 2024, 8, 42.
25. S. Haddadin, A. De Luca, A. Albu-Schaffer, IEEE Trans. Robot. 2017, 33, 1292.
26. Y. J. Heo, D. Kim, W. Lee, H. Kim, J. Park, W. K. Chung, IEEE Robot. Autom. Lett. 2019, 4, 740.
27. G. Li, S. Liu, Q. Mao, R. Zhu, Advanced Science 2022, 9, 2104969.
28. Q. Shu, Y. Pang, Q. Li, Y. Gu, Z. Liu, B. Liu, J. Li, Y. Li, J. Mater. Chem. A 2024, 12, 9296.
29. H. Oh, G.-C. Yi, M. Yip, S. A. Dayeh, Sci. Adv. 2020, 6, eabd7795.
30. J. He, X. Guo, J. Yu, S. Qian, X. Hou, M. Cui, Y. Yang, J. Mu, W. Geng, X. Chou, Nanotechnology 2020, 31, 155503.
[31] X. Chen, Y. Luo, Y. Chen, S. Li, S. Deng, B. Wang, Q. Zhang, X. Li, X. Li, C. Wang, J. He, H. Tian, J. Shao, Advanced Science 2024, 2408082.
[32] C. Xu, Y. Wang, J. Zhang, J. Wan, Z. Xiang, Z. Nie, J. Xu, X. Lin, P. Zhao, Y. Wang, S. Zhang, J. Zhang, C. Liu, N. Xue, W. Zhao, M. Han, Sci. Adv. 2024, 10, eadp6094.
[33] J. Yu, X. Hou, M. Cui, S. Zhang, J. He, W. Geng, J. Mu, X. Chou, Nano Energy 2019, 64, 103923.
[34] X. Qu, J. Xue, Y. Liu, W. Rao, Z. Liu, Z. Li, Nano Energy 2022, 98, 107324.
[35] J. An, T.-S. D. Le, Y. Huang, Z. Zhan, Y. Li, L. Zheng, W. Huang, G. Sun, Y.-J. Kim, ACS Appl. Mater. Interfaces 2017, 9, 44593.
[36] S. Pyo, J. Choi, J. Kim, Adv Elect Materials 2018, 4, 1700427.
[37] H. Sun, G. Martius, Sci. Robot. 2022, 7, eabm0608.
[38] X. Pu, Q. Tang, W. Chen, Z. Huang, G. Liu, Q. Zeng, J. Chen, H. Guo, L. Xin, C. Hu, Nano Energy 2020, 76, 105047.
[39] Z. Yan, L. Wang, Y. Xia, R. Qiu, W. Liu, M. Wu, Y. Zhu, S. Zhu, C. Jia, M. Zhu, R. Cao, Z. Li, X. Wang, Adv Funct Materials 2021, 31, 2100709.
[40] Y. Luo, M. R. Abidian, et al., ACS Nano 2023, 17, 5211.
[41] X.-F. Zhao, C.-Z. Hang, X.-H. Wen, M.-Y. Liu, H. Zhang, F. Yang, R.-G. Ma, J.-C. Wang, D. W. Zhang, H.-L. Lu, ACS Appl. Mater. Interfaces 2020, 12, 14136.
[42] Y. Zhang, L. Wang, L. Zhao, K. Wang, Y. Zheng, Z. Yuan, D. Wang, X. Fu, G. Shen, W. Han, Advanced Materials 2021, 33, 2007890.
[43] Z. Huang, L. Li, T. Wu, T. Xue, W. Sun, Q. Pan, H. Wang, H. Xie, J. Chi, T. Han, X. Hu, M. Su, Y. Chen, Y. Song, Nat Commun 2023, 14, 1204.
[44] K. Yao, J. Zhou, Q. Huang, M. Wu, C. K. Yiu, J. Li, X. Huang, D. Li, J. Su, S. Hou, Y. Liu, Y. Huang, Z. Tian, J. Li, H. Li, R. Shi, B. Zhang, J. Zhu, T. H. Wong, H. Jia, Z. Gao, Y. Gao, Y. Zhou, W. Park, E. Song, M. Han, H. Zhang, J. Yu, L. Wang, W. J. Li, X. Yu, Nat Mach Intell 2022, 4, 893.
[45] P. Jia, Q. Zhang, Z. Ren, J. Yin, D. Lei, W. Lu, Q. Yao, M. Deng, Y. Gao, N. Liu, Chemical Engineering Journal 2024, 479, 147586.
[46] J. Han, C. Xu, J. Zhang, N. Xu, Y. Xiong, X. Cao, Y. Liang, L. Zheng, J. Sun, J. Zhai, Q. Sun, Z. L. Wang, ACS Nano 2021, 15, 1597.
[47] W. Wang, L. Xu, L. Zhang, A. Zhang, J. Zhang, Small 2023, 19, 2207723.
[48] H. Bai, S. Li, J. Barreiros, Y. Tu, C. R. Pollock, R. F. Shepherd, Science 2020, 370, 848.
[49] C. Wang, C. Liu, F. Shang, S. Niu, L. Ke, N. Zhang, B. Ma, R. Li, X. Sun, S. Zhang, Biosensors and Bioelectronics 2023, 220, 114882.
[50] Z. Ding, Z. Zhang, Optics & Laser Technology 2021, 136, 106760.
[51] N. Shabalov, A. Wolf, A. Kokhanovskiy, A. Dostovalov, S. Babin, Sensors and Actuators A: Physical 2024, 369, 115219.
[52] X. S. Yao, X. (James) Chen, Polarization Measurement and Control in Optical Fiber Communication and Sensor Systems, John Wiley & Sons 2022.
[53] T. Feng, Y. Shang, X. Wang, S. Wu, A. Khomenko, X. Chen, X. S. Yao, Opt. Express 2018, 26, 25989.
[54] T. Feng, J. Zhou, Y. Shang, X. Chen, X. Steve Yao, Opt. Express 2020, 28, 31253.
[55] T. Feng, T. Miao, Z. Lu, X. S. Yao, Opt. Express 2022, 30, 5347.
[56] X. S. Yao, L. Yan, Y. Shi, Opt. Lett. 2005, 30, 1324.
[57] X. S. Yao, X. Chen, L. Yan, Opt. Lett. 2006, 31, 1948.
[58] X. S. Yao, X. Chen, T. Liu, Opt. Express 2010, 18, 6667.
[59] Z. Ding, T. Liu, Z. Meng, K. Liu, Q. Chen, Y. Du, D. Li, X. S. Yao, Review of Scientific Instruments 2012, 83, 066110.
[60] Z. Ding, X. S. Yao, T. Liu, Y. Du, K. Liu, J. Jiang, Z. Meng, H. Chen, Opt. Express, OE 2013, 21, 3826.
[61] X. Ma, X. S. Yao, Journal of Lightwave Technology 2024, 42, 4569.
[62] J. Stone, JOURNAL OF LIGHTWAVE TECHNOLOGY 1988, 6.
[63] S. R. Norman, D. N. Payne, M. J. Adams, A. M. Smith, Electronics Letters 1979, 15, 309.
[64] X. S. Yao, Sine-cosine optical frequency detection devices for photonics integrated circuits and applications in LiDAR and other distributed optical sensing, 2023.
[65] X. S. Yao, Y. Yang, X. Ma, Z. Lin, Y. Zhu, W. Ke, H. Tan, X. Wang, X. Cai, On-chip real-time detection of optical frequency variations with ultrahigh resolution using the sine-cosine encoder approach, arXiv 2025.
[66] Z. Lin, Y. Lin, H. Li, M. Xu, M. He, W. Ke, H. Tan, Y. Han, Z. Li, D. Wang, X. S. Yao, S. Fu, S. Yu, X. Cai, Light Sci Appl 2022, 11, 93.
[67] M. Luo, J. Liu, C. Tang, X. Wang, T. Lan, B. Kan, Opt. Express, OE 2019, 27, 35823.
[68] J. Song, W. Li, P. Lu, Y. Xu, L. Chen, X. Bao, IEEE Photonics Journal 2014, 6, 1.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations, enhancements and variations can be made based on what is described and illustrated in this patent document.

What is claimed is what is described and illustrated, including:

1. A multi-layer device capable of sensing, comprising:
a top layer that is deformable and includes force sensing elements spatially distributed relative to one another, each force sensing element structured to transmit a force exerted on a first end of the sensing element on a first side of the top layer to a second end of the forcing sensing element on a second side of the top layer opposite to the first side, wherein the force sensing elements are formed by an array of sensing pads and thin strips that interconnect adjacent sensing pads;
a middle layer that is deformable and is engaged to the top layer, the middle layer including a sensing optical fiber that is located on the second side of the top layer and arranged in a serpentine pattern to spatially distribute over the middle layer, wherein the sensing optical fiber is coupled to the force sensing elements at different locations along the serpentine pattern of the sensing optical fiber, and includes a first terminal that receives input light and a second terminal, and is coupled to the second end of each force sensing element to receive a force transmitted from the force sensing element to exhibit a localized birefringence in the sensing optical fiber induced by the transmitted force at a location of the sensing optical fiber coupled to the force sensing element to indicate the transmitted force so that different locations of the sensing optical fiber coupled to the different force sensing elements generate a spatially distributed sensing of forces experienced by the different force sensing elements; and
a bottom layer structured to be deformable engaged to the middle layer.

2. The device as in claim 1, wherein the force sensing elements formed by the array of sensing pads and thin strips that interconnect adjacent sensing pads are made of a metal or an alloy material.

3. The device as in claim 1, wherein the force sensing elements formed by the array of sensing pads and thin strips that interconnect adjacent sensing pads are a thin stainless steel sheet material.

4. The device as in claim 1, comprising:
an optical detection module coupled to the first terminal of the optical fiber to launch light into the optical fiber and receive backscattered light from the optical fiber for measuring the light that carries information of the localized birefringence in the fiber induced by transmitted forces by the different force sensing elements.

5. The device as in claim 4, wherein the optical detection module includes an optical frequency domain reflectometer (OFDR) with polarization analysis capability for obtaining distance resolved birefringence along the optical fiber with high spatial resolution.

6. The device as in claim 4, wherein the optical detection module includes a time domain reflectometer (OTDR) with polarization analysis capability for obtaining distance resolved birefringence along the optical fiber with high spatial resolution.

7. The device as in claim 4, wherein the optical detection module includes a pulsed light source to generate light pulses to the optical fiber and is configured to detect returned light pulses from the optical fiber to measure a spatial distribution of the force or temperature in the optical fiber based on Brillouin time domain reflectometry (BOTDR) measurements.

8. The device as in claim 1, comprising:
an optical detection module that includes a first optical port coupled to the first terminal of the optical fiber to send light into the optical fiber and a second optical port coupled to the second terminal of the fiber to receive light from the optical fiber and to include an optical interferometer to process the received light from the optical fiber to produce an interferometer optical output having polarization crosstalk peaks with their amplitude indicative of the forces exerted on the optical fiber, and the optical detection module is configured to measure both the amplitudes and spacings of the polarization crosstalk peaks to determine temperature distribution along the optical fiber.

9. The device as in claim 8, wherein the optical detection module includes a distributed polarization crosstalk analyzer (DPXA) that processes the received light from the optical fiber to measure distance resolved polarization crosstalk peaks along the optical fiber, with their amplitudes indicative of the force and the spacings indicative of the local temperature.

10. The device as in claim 8, wherein the optical detection module includes a pulsed light source to generate light pulses to the optical fiber and the optical detection module is configured to detect returned light pulses from the optical fiber to measure a spatial distribution of the force or temperature in the optical fiber based on Brillouin time domain reflectometry (BOTDR) measurements.

11. The device as in claim 1, comprising:
an optical detection module coupled to the first terminal of the optical fiber to launch light into the optical fiber and receive light from the optical fiber and to measure the light that carries information of the localized birefringence in the optical fiber induced by transmitted forces by the different force sensing elements, wherein the optical detection module is further configured to process the received light from the optical fiber to measure a spatial temperature and strain distributions along the length of the optical fiber.

12. The device as in claim 1, wherein, in the force sensing elements formed by the array of sensing pads and thin strips that interconnect adjacent sensing pads, each thin strip is a straight strip.

13. The device as in claim 1, wherein, in the force sensing elements formed by the array of sensing pads and thin strips that interconnect adjacent sensing pads, each thin strip is a curved wiggling strip.

14. The device as in claim 1, wherein the middle layer further includes a support plate and pillars fixed to the support plate so that the sensing optical fiber is wounded around the pillars to form the serpentine pattern.
